(19) United States
(12) Patent Application Publication
(10) Pub. No.: US 2026/0143506 A1
(43) Pub. Date: May 21, 2026

(54) METHOD AND DEVICE FOR PERFORMING CHANNEL ACCESS IN UNLICENSED BAND

(71) Applicant: LG ELECTRONICS INC., Seoul (KR)

(72) Inventors: Seungmin LEE, Seoul (KR); Daesung HWANG, Seoul (KR)

(73) Assignee: LG ELECTRONICS INC., Seoul (KR)

(21) Appl. No.: 19/123,353

(22) PCT Filed: Nov. 1, 2023
(86) PCT No.: PCT/KR2023/017245

§ 371 Date: Apr. 22, 2025

Related U.S. Application Data
(60) Provisional application No. 63/421,558, filed on Nov. 1, 2022.
(60) Provisional application No. 63/422,421, filed on Nov. 3, 2022.

(51) Int. Cl. H04W 72/25; H04W 64/00

(52) U.S. Cl. CPC H04W 72/25; H04W 64/00

(57) ABSTRACT

Provided are a method by which a first device performs wireless communication, and a device for supporting same. The method may comprise the steps of: acquiring configuration information for dynamic channel access; acquiring configuration information for semi-static channel access; performing the dynamic channel access or the semi-static channel access on the basis of information acquired by the first device; transmitting, to a second device, on the basis of success in the dynamic channel access or the semi-static channel access, first sidelink control information (SCI) for scheduling of a physical sidelink shared channel (PSSCH) and second SCI through a physical sidelink control channel (PSCCH); and transmitting the second SCI and data to the second device through the PSSCH.

### CROSS-REFERENCE TO RELATED APPLICATIONS

This application is the National Stage filing under 35 U.S.C. 371 of International Application No. PCT/KR2023/017245, filed on Nov. 1, 2023, which claims the benefit of U.S. Provisional Application Nos. 63/421,558 filed on Nov. 1, 2022, and 63/422,421 filed on Nov. 3, 2022, the contents of which are all hereby incorporated by reference herein in their entireties.

### TECHNICAL FIELD

This disclosure relates to a wireless communication system.

### BACKGROUND

Sidelink (SL) communication is a communication scheme in which a direct link is established between User Equipments (UEs) and the UEs exchange voice and data directly with each other without intervention of a base station. SL communication is under consideration as a solution to the overhead of a base station caused by rapidly increasing data traffic. Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR).

### SUMMARY

In an embodiment, provided is a method for performing wireless communication by a first device. The method may comprise: obtaining configuration information for dynamic channel access: obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

In an embodiment, provided is a first device adapted to perform wireless communication. The first device may comprise: at least one transceiver: at least one processor; and at least one memory connected to the at least one processor and storing instructions that, based on being executed by the at least one processor, cause the first device to perform operations comprising: obtaining configuration information for dynamic channel access; obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

In an embodiment, provided is a processing device adapted to control a first device. The processing device may comprise: at least one processor; and at least one memory connected to the at least one processor and storing instructions that, based on being executed by the at least one processor, cause the first device to perform operations comprising: obtaining configuration information for dynamic channel access: obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

In an embodiment, provided is a non-transitory computer-readable storage medium storing instructions. The instructions, when executed, may cause a first device to perform operations comprising: obtaining configuration information for dynamic channel access; obtaining configuration information for semi-static channel access: performing, based on information obtained by the first device, the dynamic channel access or the semi-static channel access; transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

### BRIEF DESCRIPTION OF THE DRAWINGS

FIG. 1 shows a communication structure providable in a 6G system, based on an embodiment of the present disclosure.

FIG. 2 shows an electromagnetic spectrum, based on an embodiment of the present disclosure.

FIG. 3 shows a structure of an NR system, based on an embodiment of the present disclosure.

FIG. 4 shows a radio protocol architecture, based on an embodiment of the present disclosure.

FIG. 5 shows a structure of a radio frame of an NR, based on an embodiment of the present disclosure.

FIG. 6 shows a structure of a slot of an NR frame, based on an embodiment of the present disclosure.

FIG. 7 shows an example of a BWP, based on an embodiment of the present disclosure.

FIG. 8 shows a procedure of performing V2X or SL communication by a UE based on a transmission mode, based on an embodiment of the present disclosure.

FIG. 9 shows three cast types, based on an embodiment of the present disclosure.

FIG. 10 shows an interlaced RB, based on an embodiment of the present disclosure.

FIG. 11 shows a channel access procedure, based on an embodiment of the present disclosure.

FIG. 12 shows a procedure for a UE to perform sidelink communication based on a dynamic channel access procedure or a semi-static channel access procedure, based on an embodiment of the present disclosure.

FIG. 13 shows an example of sub-channelization for contiguous RB-based PSCCH/PSSCH transmission, based on an embodiment of the present disclosure.

FIG. 14 shows an example of sub-channelization for contiguous RB-based PSCCH/PSSCH transmission, based on an embodiment of the present disclosure.

FIG. 15 shows an example of sub-channelization for interlaced RB-based PSCCH/PSSCH transmission, based on an embodiment of the present disclosure.

FIG. 16 shows an example of sub-channelization for interlaced RB-based PSCCH/PSSCH transmission, based on an embodiment of the present disclosure.

FIG. 17 shows an example of an additional starting position of PSCCH/PSSCH to ensure PSFCH resources in the same slot.

FIG. 18 shows an example of an additional starting position of PSCCH/PSSCH overlapping with PSCCH symbol duration of PSCCH/PSSCH with the 1^{st} starting position, based on an embodiment of the present disclosure.

FIG. 19 shows an example of an additional starting position of PSCCH/PSSCH overlapping with or without a PSSCH DMRS symbol of PSCCH/PSSCH with the 1^{st} starting position, based on an embodiment of the present disclosure.

FIG. 20 or FIG. 21 shows an example of SL burst transmission, based on an embodiment of the present disclosure.

FIG. 22 shows an example of PSSCH-to-PSFCH mapping for handling PSFCH TX dropping due to LBT failure.

FIG. 23 shows an example of PSSCH-to-PSFCH mapping for handling PSFCH TX dropping due to LBT failure, based on an embodiment of the present disclosure.

FIGS. 24 to 26 show the detection performance of S-PSS and S-SSS, based on an embodiment of the present disclosure.

FIG. 27 shows a method for a first device to perform wireless communication, based on an embodiment of the present disclosure.

FIG. 28 shows a method for a second device to perform wireless communication, based on an embodiment of the present disclosure.

FIG. 29 shows a communication system 1, based on an embodiment of the present disclosure.

FIG. 30 shows wireless devices, based on an embodiment of the present disclosure.

FIG. 31 shows a signal process circuit for a transmission signal, based on an embodiment of the present disclosure.

FIG. 32 shows another example of a wireless device, based on an embodiment of the present disclosure.

FIG. 33 shows a hand-held device, based on an embodiment of the present disclosure.

FIG. 34 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A. B. C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A. B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, “when, if, or in case of” may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHZ, middle frequency bands ranging from 1 GHz to 10 GHz, high frequency (millimeter waves) of 24 GHz or more, and so on.

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as intelligent connectivity, deep connectivity, holographic connectivity and ubiquitous connectivity, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile internet, high throughput, high network capacity, high energy efficiency, low backhaul and access network congestion, and enhanced data security.

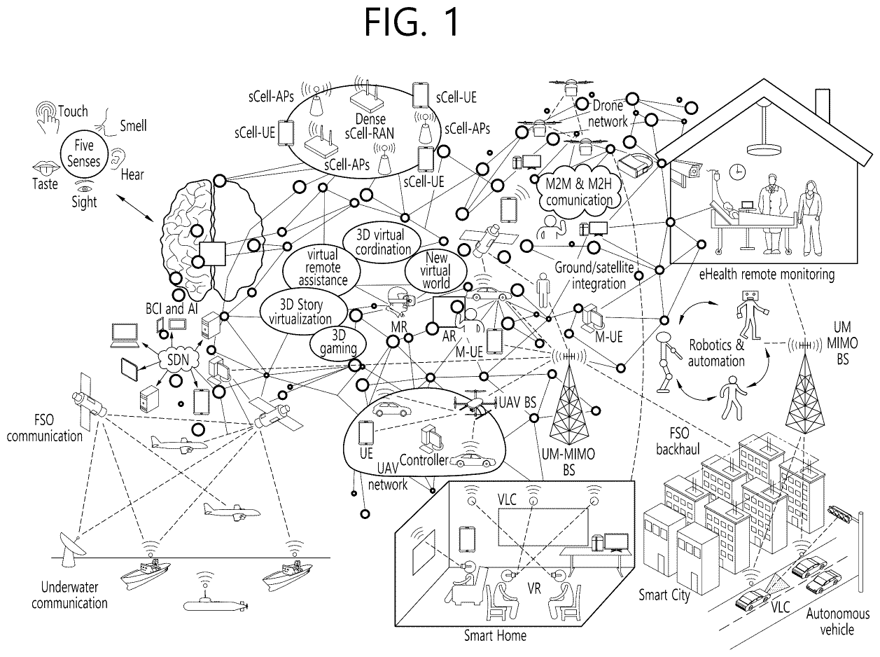

FIG. 1 shows a communication structure providable in a 6G system, based on an embodiment of the present disclosure. The embodiment of FIG. 1 may be combined with various embodiments of the present disclosure.

The 6G system will have 50 times higher simultaneous wireless communication connectivity than a 5G wireless communication system. URLLC, which is the key feature of 5G, will become more important technology by providing end-to-end latency less than 1 ms in 6G communication. The 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

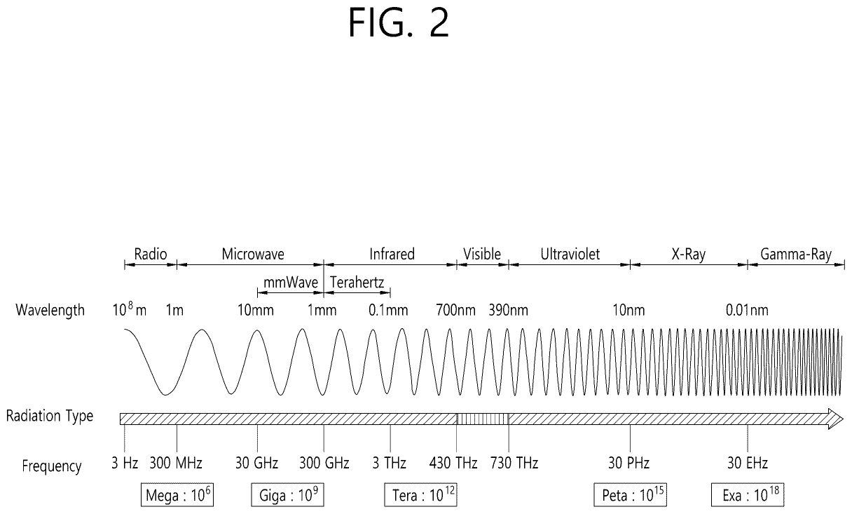

Core implementation technology of 6G system is described below:
Artificial Intelligence (AI): Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is. AI may increase efficiency and reduce processing delay. Operation consuming time such as handover, network selection, and resource scheduling immediately performed by using AI. AI may also play an important role in M2M, machine-to-human, and human-to-machine. In addition. AI may be a prompt communication in brain computer interface (BCI). An AI based communication system may be supported by metamaterial, intelligence structure, intelligence network, intelligence device, intelligence cognitive radio, self-maintaining wireless network, and machine learning.
Terahertz (THz) communication: A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHZ (sub THZ band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF. FIG. 2 shows an electromagnetic spectrum, based on an embodiment of the present disclosure. The embodiment of FIG. 2 may be combined with various embodiments of the present disclosure. The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.
Massive MIMO technology (large-scale MIMO)
Hologram beamforming (HBF)
Optical wireless technology
Free space optical backhaul network (FSO Backhaul Network)
Non-terrestrial networks (NTN)
Quantum communication
Cell-free communication
Integration of wireless information and power transmission
Integration of wireless communication and sensing
Integrated access and backhaul network
Big data analysis
Reconfigurable intelligent surface
Metaverse
Block-chain
Unmanned aerial vehicle (UAV): An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB. URLLC and mMTC. The UAV can also serve a number of purposes, such as network connectivity improvement, fire detection, disaster emergency services, security and surveillance, pollution monitoring, parking monitoring, and accident monitoring. Therefore. UAV technology is recognized as one of the most important technologies for 6G communication.
Autonomous driving (self-driving): For perfect autonomous driving, it is necessary to notify dangerous situation of each other through communication between vehicle and vehicle, to check information like parking information location and signal change time through communication between vehicle and infrastructure such as parking lots and/or traffic lights. Vehicle to everything (V2X) that is a core element for establishing an autonomous driving infrastructure is a technology that vehicle communicates and shares with various elements in road for autonomous driving such as vehicle to vehicle (V2V), vehicle to infrastructure (V2I). To maximize a performance of autonomous driving and to secure high safety, high transmission speed and low latency technology have to be needed. Furthermore, to directly control vehicle in dangerous situation and to actively intervene vehicle driving beyond a level of a warning or a guidance message to driver, as the amount of the information to transmit and receive is larger, autonomous driving is expected to be maximized in 6G being higher transmission speed and lower latency than 5G.

For clarity in the description. 5G NR is mainly described, but the technical idea according to an embodiment of the present disclosure is not limited thereto. Various embodiments of the present disclosure can also be applied to 6G communication systems.

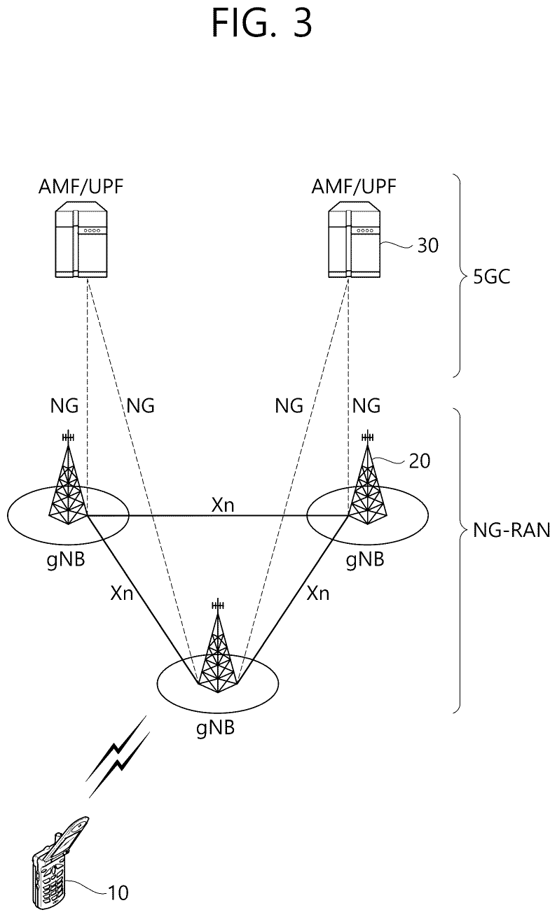

FIG. 3 shows a structure of an NR system, based on an embodiment of the present disclosure. The embodiment of FIG. 3 may be combined with various embodiments of the present disclosure.

Referring to FIG. 3, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 3 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

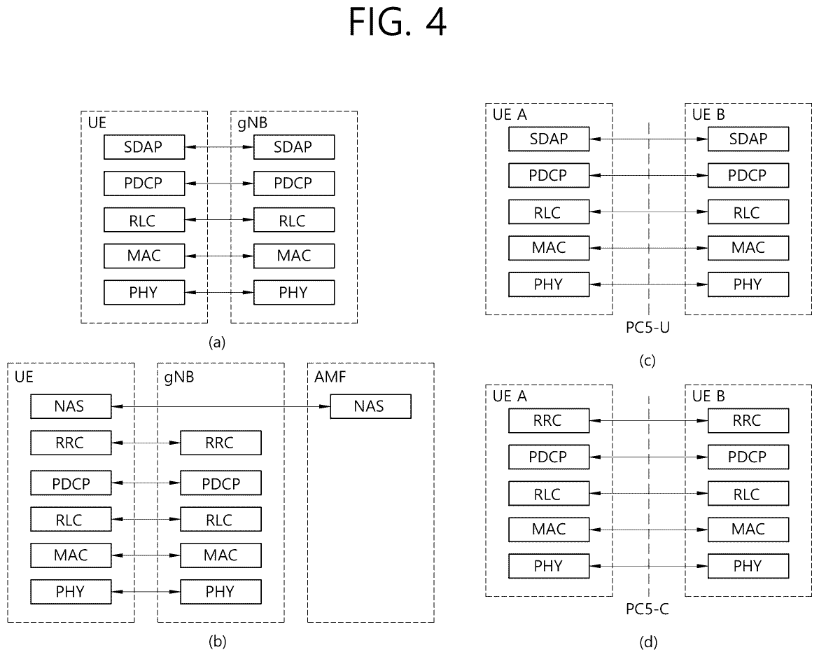

FIG. 4 shows a radio protocol architecture, based on an embodiment of the present disclosure. The embodiment of FIG. 4 may be combined with various embodiments of the present disclosure. Specifically, (a) of FIG. 4 shows a radio protocol stack of a user plane for Uu communication, and (b) of FIG. 4 shows a radio protocol stack of a control plane for Uu communication, (c) of FIG. 4 shows a radio protocol stack of a user plane for SL communication, and (d) of FIG. 4 shows a radio protocol stack of a control plane for SL communication.

Referring to FIG. 4, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers. i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QOS) required by a radio bearer (RB), the RLC layer provides three types of operation modes. i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, a packet data convergence protocol (PDCP) layer, and a service data adaptation protocol (SDAP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QOS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types. i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

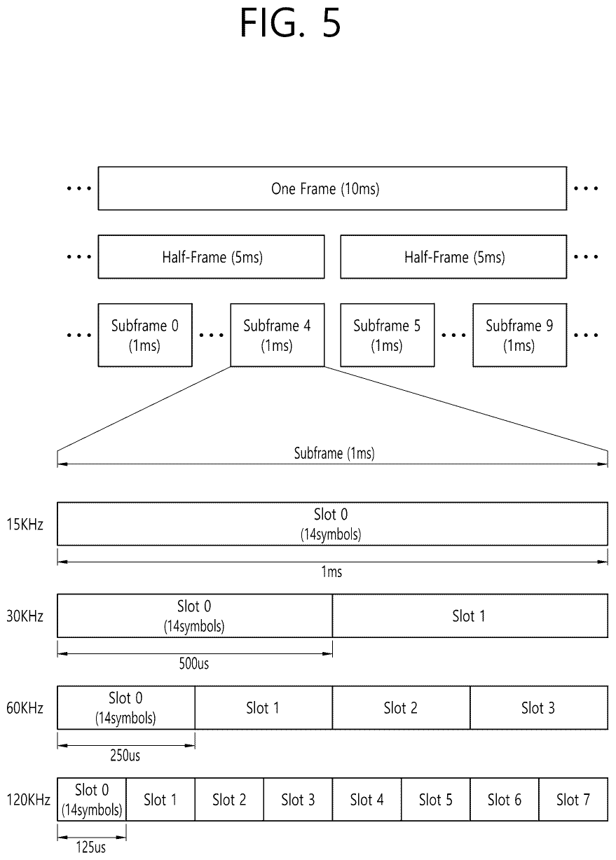

FIG. 5 shows a structure of a radio frame of an NR, based on an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM (A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 2 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP or an extended CP is used.

TABLE 2

| CP type | SCS (15*2^{u}) | N^{slot}_{symb} | N^{frame, u}ₛₗₒₜ | N^{subframe, u}ₛₗₒₜ |
|---|---|---|---|---|
| normal CP | 15 kHz (u = 0) | 14 | 10 | 1 |
| | 30 kHz (u = 1) | 14 | 20 | 2 |
| | 60 kHz (u = 2) | 14 | 40 | 4 |
| | 120 kHz (u = 3) | 14 | 80 | 8 |
| | 240 kHz (u = 4) | 14 | 160 | 16 |
| extended CP | 60 kHz (u = 2) | 12 | 40 | 4 |

In an NR system, OFDM (A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 KHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | Subcarrier | |
|---|---|---|---|
| designation | frequency range | Spacing (SCS) | |
| FR1 | 410 MHz-7125 MHz | 15, 30, 60 | kHz |
| FR2 | 24250 MHz-52600 MHz | 60, 120, 240 | kHz |

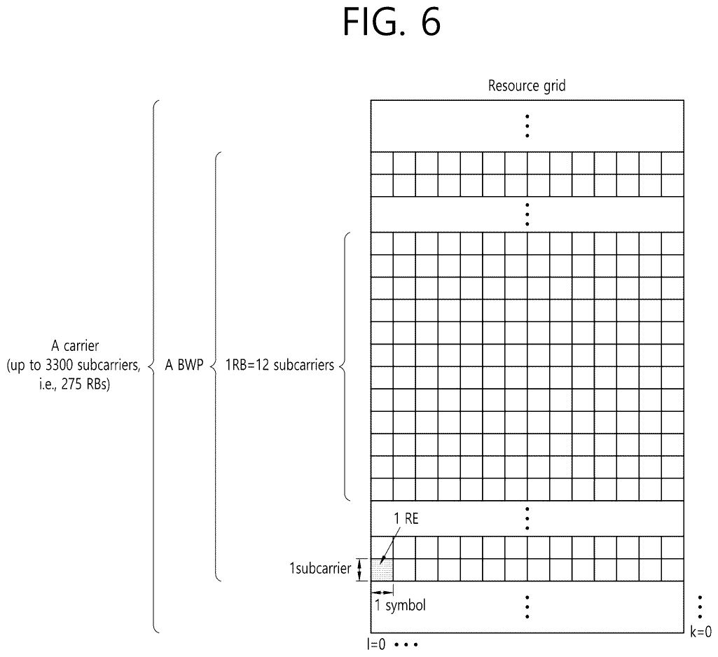

FIG. 6 shows a structure of a slot of an NR frame, based on an embodiment of the present disclosure. The embodiment of FIG. 6 may be combined with various embodiments of the present disclosure.

Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information-reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit a SL channel or a SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. For example, the UE may receive a configuration for the Uu BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

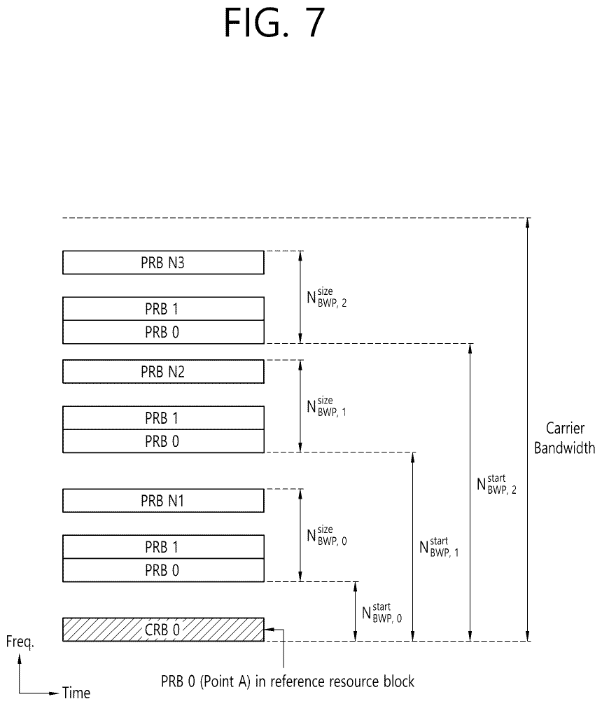

FIG. 7 shows an example of a BWP, based on an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter. V2X or SL communication will be described.

A sidelink synchronization signal (SLSS) may include a primary sidelink synchronization signal (PSSS) and a secondary sidelink synchronization signal (SSSS), as a SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

For example, the UE may generate an S-SS/PSBCH block (i.e., S-SSB), and the UE may transmit the S-SS/PSBCH block (i.e., S-SSB) by mapping it on a physical resource. For example, the time-frequency structure of the S-SS/PSBCH block may be as follows.

In the time domain, an S-SS/PSBCH block may consist of N^{S-SSB}_{symb} OFDM symbols, numbered in increasing order from 0 to N^{S-SSB}_{symb}−1 within the S-SS/PSBCH block, where S-PSS, S-SSS, and PSBCH with associated DM-RS may be mapped to symbols as given by Table 5. The number of OFDM symbols in an S-SS/PSBCH block may be N^{S-SSB}_{symb}=13 for normal cyclic prefix and N^{S-SSB}_{symb}=11 for extended cyclic prefix. The first OFDM symbol in an S-SS/PSBCH block may be the first OFDM symbol in the slot.

In the frequency domain, an S-SS/PSBCH block may consist of 132 contiguous subcarriers with the subcarriers numbered in increasing order from 0 to 131 within the sidelink S-SS/PSBCH block. The quantities k and l may represent the frequency and time indices, respectively, within one sidelink S-SS/PSBCH block.

TABLE 5

| | OFDM symbol number 1 | Subcarrier number k |
|---|---|---|
| Channel or | relative to the start of | relative to the start of |
| signal | an S-SS/PSBCH block | an S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N^{S-SSB}_{symb}-1 | 0, 1, . . . , 131 |
| DM-RS for | 0, 5, 6, . . . , N^{S-SSB}_{symb}-1 | 0, 4, 8, . . . , 128 |
| PSBCH | | |

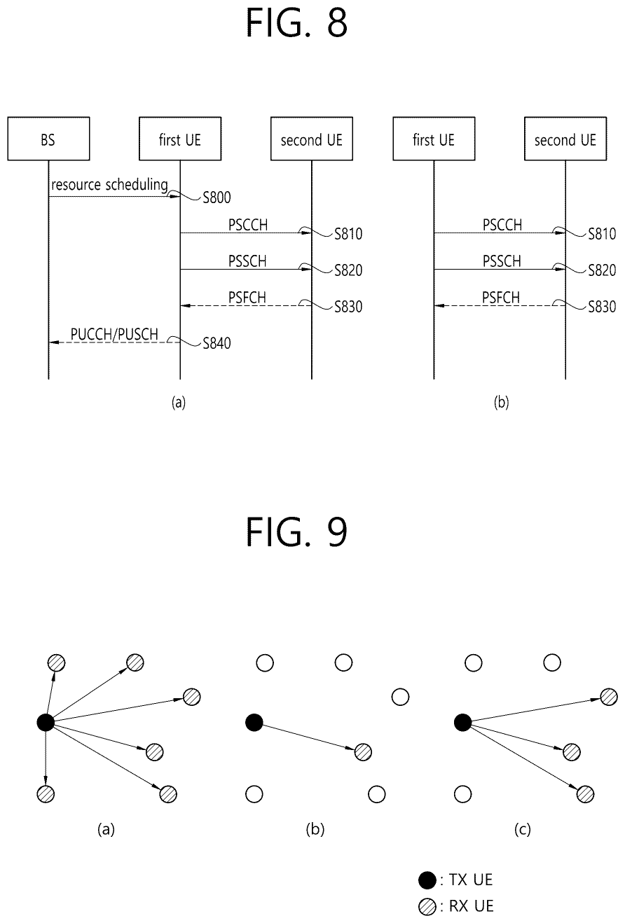

FIG. 8 shows a procedure of performing V2X or SL communication by a UE based on a transmission mode, based on an embodiment of the present disclosure. The embodiment of FIG. 8 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, (a) of FIG. 8 shows a UE operation related to an LTE transmission mode 1 or an LTE transmission mode 3. Alternatively, for example, (a) of FIG. 8 shows a UE operation related to an NR resource allocation mode 1. For example, the LTE transmission mode 1 may be applied to general SL communication, and the LTE transmission mode 3 may be applied to V2X communication.

For example, (b) of FIG. 8 shows a UE operation related to an LTE transmission mode 2 or an LTE transmission mode 4. Alternatively, for example, (b) of FIG. 8 shows a UE operation related to an NR resource allocation mode 2.

Referring to (a) of FIG. 8, in the LTE transmission mode 1, the LTE transmission mode 3, or the NR resource allocation mode 1, a base station may schedule SL resource(s) to be used by a UE for SL transmission. For example, in step S800, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S810, the first UE may transmit a PSCCH (e.g., sidelink control information (SCI) or 1^{st}-stage SCI) to a second UE based on the resource scheduling. In step S820, the first UE may transmit a PSSCH (e.g., 2^{nd}-stage SCI, MAC PDU, data, etc.) related to the PSCCH to the second UE. In step S830, the first UE may receive a PSFCH related to the PSCCH/PSSCH from the second UE. For example, HARQ feedback information (e.g., NACK information or ACK information) may be received from the second UE through the PSFCH. In step S840, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1.

Hereinafter, an example of DCI format 3_0 will be described.

DCI format 3_0) is used for scheduling of NR PSCCH and NR PSSCH in one cell.

The following information is transmitted by means of the DCI format 3_0 with CRC scrambled by SL-RNTI or SL-CS-RNTI:
Resource pool index—ceiling (log₂ I) bits, where I is the number of resource pools for transmission configured by the higher layer parameter sl-TxPoolScheduling.
Time gap—3 bits determined by higher layer parameter sl-DCI-ToSL-Trans
HARQ process number—4 bits
New data indicator—1 bit
Lowest index of the subchannel allocation to the initial transmission—ceiling (log₂(N^{SL}_{subChannel})) bits
SCI format 1—A fields: frequency resource assignment, time resource assignment
PSFCH-to-HARQ feedback timing indicator—ceiling (log₂ N_{fb_timing}) bits, where N_{fb_timing} is the number of entries in the higher layer parameter sl-PSFCH-ToPUCCH.
PUCCH resource indicator—3 bits
Configuration index—0 bit if the UE is not configured to monitor DCI format 3_0 with CRC scrambled by SL-CS-RNTI: otherwise 3 bits. If the UE is configured to monitor DCI format 3_0 with CRC scrambled by SL-CS-RNTI, this field is reserved for DCI format 3_0) with CRC scrambled by SL-RNTI.
Counter sidelink assignment index—2 bits, 2 bits if the UE is configured with pdsch-HARQ-ACK-Codebook=dynamic. 2 bits if the UE is configured with pdsch-HARQ-ACK-Codebook=semi-static
Padding bits, if required

Referring to (b) of FIG. 8, in the LTE transmission mode 2, the LTE transmission mode 4, or the NR resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re)selection procedure. For example, the sensing may be performed in a unit of subchannel(s). For example, in step S810, a first UE which has selected resource(s) from a resource pool by itself may transmit a PSCCH (e.g., sidelink control information (SCI) or 1^{st}-stage SCI) to a second UE by using the resource(s). In step S820, the first UE may transmit a PSSCH (e.g., 2^{nd}-stage SCI, MAC PDU, data, etc.) related to the PSCCH to the second UE. In step S830, the first UE may receive a PSFCH related to the PSCCH/PSSCH from the second UE.

Referring to (a) or (b) of FIG. 8, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A. and the 2^{nd}-stage SCI format may include a SCI format 2-A and/or a SCI format 2-B.

Hereinafter, an example of SCI format 1-A will be described.

SCI format 1—A is used for the scheduling of PSSCH and 2^{nd}-stage-SCI on PSSCH.

The following information is transmitted by means of the SCI format 1-A:
Priority—3 bits
Frequency resource assignment—ceiling (log₂(N^{SL}_{subChannel}(N^{SL}_{subChannel}+1)/2)) bits
   when the value of the higher layer parameter sl-MaxNumPerReserve is configured to 2; otherwise ceiling log₂(N^{SL}_{subChannel}(N^{SL}_{subChannel}+1) (2N^{SL}_{subChannel}+1)/6) bits when the value of the higher layer parameter sl-MaxNumPerReserve is configured to 3
Time resource assignment—5 bits when the value of the higher layer parameter sl-MaxNumPerReserve is configured to 2; otherwise 9 bits when the value of the higher layer parameter sl-MaxNumPerReserve is configured to 3
Resource reservation period—ceiling (log₂ N_{rsv_period}) bits, where N_{rsv_period} is the number of entries in the higher layer parameter sl-ResourceReservePeriodList, if higher layer parameter sl-MultiReserveResource is configured: 0 bit otherwise
DMRS pattern—ceiling (log₂ Nₚₐₜₜₑᵣₙ) bits, where Nₚₐₜₜₑᵣₙ is the number of DMRS patterns configured by higher layer parameter sl-PSSCH-DMRS-TimePatternList
2^{nd}-stage SCI format—2 bits as defined in Table 6
Beta_offset indicator—2 bits as provided by higher layer parameter sl-BetaOffsets2ndSCI
Number of DMRS port
Modulation and coding scheme—5 bits
Additional MCS table indicator—1 bit if one MCS table is configured by higher layer parameter sl-Additional-MCS-Table: 2 bits if two MCS tables are configured by higher layer parameter sl-Additional-MCS-Table: 0 bit otherwise
PSFCH overhead indication—1 bit if higher layer parameter sl-PSFCH-Period=2 or 4:0 bit otherwise
Reserved—a number of bits as determined by higher layer parameter sl-NumReservedBits, with value set to zero.

TABLE 6

| Value of 2nd-stage SCI format field | 2nd-stage SCI format |
|---|---|
| 00 | SCI format 2-A |
| 01 | SCI format 2-B |
| 10 | Reserved |
| 11 | Reserved |

Hereinafter, an example of SCI format 2-A will be described.

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number—4 bits
New data indicator—1 bit
Redundancy version—2 bits
Source ID—8 bits
Destination ID—16 bits
HARQ feedback enabled/disabled indicator—1 bit
Cast type indicator—2 bits as defined in Table 7
CSI request—1 bit

TABLE 7

| Value of Cast | |
|---|---|
| type indicator | Cast type |
| 00 | Broadcast |
| 01 | Groupcast when HARQ-ACK information |
| | includes ACK or NACK |
| 10 | Unicast |
| 11 | Groupcast when HARQ-ACK information |
| | includes only NACK |

Hereinafter, an example of SCI format 2-B will be described.

SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—4 bits
New data indicator—1 bit
Redundancy version—2 bits
Source ID—8 bits
Destination ID—16 bits
HARQ feedback enabled/disabled indicator—1 bit
Zone ID—12 bits
Communication range requirement—4 bits determined by higher layer parameter sl-ZoneConfigMCR-Index

Referring to (a) or (b) of FIG. 8, in step S830, the first UE may receive the PSFCH. For example, the first UE and the second UE may determine a PSFCH resource, and the second UE may transmit HARQ feedback to the first UE using the PSFCH resource.

Referring to (a) of FIG. 8, in step S840, the first UE may transmit SL HARQ feedback to the base station through the PUCCH and/or the PUSCH.

FIG. 9 shows three cast types, based on an embodiment of the present disclosure. The embodiment of FIG. 9 may be combined with various embodiments of the present disclosure. Specifically. (a) of FIG. 9 shows broadcast-type SL communication. (b) of FIG. 9 shows unicast type-SL communication, and (c) of FIG. 9 shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure. SL groupcast communication may be replaced with SL multicast communication. SL one-to-many communication, or the like. Hereinafter, a hybrid automatic repeat request (HARQ) procedure will be described.

For example, the SL HARQ feedback may be enabled for unicast. For example, the SL HARQ feedback may be enabled for groupcast. For example, two HARQ feedback options may be supported for groupcast.
(1) Groupcast option 1: After the receiving UE decodes the PSCCH of which the target is the receiving UE, if the receiving UE fails in decoding of a transport block related to the PSCCH, the receiving UE may transmit negative acknowledgement (NACK) to the transmitting UE through a PSFCH. Otherwise, if the receiving UE decodes the PSCCH of which the target is the receiving UE and if the receiving UE successfully decodes the transport block related to the PSCCH, the receiving UE may not transmit positive acknowledgement (ACK) to the transmitting UE.
(2) Groupcast option 2: After the receiving UE decodes the PSCCH of which the target is the receiving UE, if the receiving UE fails in decoding of the transport block related to the PSCCH, the receiving UE may transmit NACK to the transmitting UE through the PSFCH. In addition, if the receiving UE decodes the PSCCH of which the target is the receiving UE and if the receiving UE successfully decodes the transport block related to the PSCCH, the receiving UE may transmit ACK to the transmitting UE through the PSFCH.

Hereinafter. UE procedure for reporting HARQ-ACK on sidelink will be described.

A UE can be indicated by an SCI format scheduling a PSSCH reception, in one or more sub-channels from a number of N^{PSSCH}_{subch} sub-channels, to transmit a PSFCH with HARQ-ACK information in response to the PSSCH reception. The UE provides HARQ-ACK information that includes ACK or NACK, or only NACK.

A UE can be provided, by sl-PSFCH-Period-r16, a number of slots in a resource pool for a period of PSFCH transmission occasion resources. If the number is zero, PSFCH transmissions from the UE in the resource pool are disabled. A UE expects that a slot t′ₖ^{SL}(0≤k<T′ₘₐₓ) has a PSFCH transmission occasion resource if k mod N^{PSFCH}_{PSSCH}=0, where t′ₖ^{SL} is a slot that belongs to the resource pool, T′ₘₐₓ is a number of slots that belong to the resource pool within 10240 msec, and N^{PSFCH}_{PSSCH} is provided by sl-PSFCH-Period-r16. A UE may be indicated by higher layers to not transmit a PSFCH in response to a PSSCH reception. If a UE receives a PSSCH in a resource pool and the HARQ feedback enabled/disabled indicator field in an associated SCI format 2-A or a SCI format 2-B has value 1, the UE provides the HARQ-ACK information in a PSFCH transmission in the resource pool. The UE transmits the PSFCH in a first slot that includes PSFCH resources and is at least a number of slots, provided by sl-MinTimeGapPSFCH-r16, of the resource pool after a last slot of the PSSCH reception.

A UE is provided by sl-PSFCH-RB-Set-r16 a set of M^{PSFCH}_{PRB,set} PRBs in a resource pool for PSFCH transmission in a PRB of the resource pool. For a number of N_{subch} sub-channels for the resource pool, provided by sl-NumSubchannel, and a number of PSSCH slots associated with a PSFCH slot that is less than or equal to N^{PSFCH}_{PSSCH}, the UE allocates the [(i+j·N^{PSFCH}_{PSSCH})·M^{PSFCH}_{subch,slot}, (i+1+j·N^{PSFCH}_{PSSCH})·M^{PSFCH}_{subch,slot}−1] PRBs from the M_{PRB,set}^{PSFCH} PRBs to slot i among the PSSCH slots associated with the PSFCH slot and sub-channel j, where M^{PSFCH}_{subch,slot}=M^{PSFCH}_{PRB,set}/(N_{subch}·N^{PSFCH}_{PSSCH}), 0≤i<N^{PSFCH}_{PSSCH}, 0≤j<N_{subch}, and the allocation starts in an ascending order of i and continues in an ascending order of j. The UE expects that M^{PSFCH}_{PRB,set} is a multiple of N_{subch}·N^{PSFCH}_{PSSCH}.

A UE determines a number of PSFCH resources available for multiplexing HARQ-ACK information in a PSFCH transmission as R^{PSFCH}_{PRB,CS} N^{PSFCH}_{type}·M^{PSFCH}_{subch,slot}·N^{PSFCH}_{CS} where N^{PSFCH}_{CS} is a number of cyclic shift pairs for the resource pool and, based on an indication by higher layers,
N^{PSFCH}_{type}=1 and the M^{PSFCH}_{subch,slot} PRBs are associated with the starting sub-channel of the corresponding PSSCH
N^{PSFCH}_{type}=N^{PSSCH}_{subch} and the N^{PSSCH}_{subch}·M^{PSFCH}_{subch,slot} PRBs are associated with one or more sub-channels from the N^{PSSCH}_{subch} sub-channels of the corresponding PSSCH

The PSFCH resources are first indexed according to an ascending order of the PRB index, from the N^{PSFCH}_{type}·M^{PSFCH}_{subch,slot} PRBs, and then according to an ascending order of the cyclic shift pair index from the N^{PSFCH}_{CS} cyclic shift pairs.

A UE determines an index of a PSFCH resource for a PSFCH transmission in response to a PSSCH reception as (P_{ID}+M_{ID})mod R^{PSFCH}_{PRB,CS} Where P_{ID} is a physical layer source ID provided by SCI format 2-A or 2-B scheduling the PSSCH reception, and M_{ID} is the identity of the UE receiving the PSSCH as indicated by higher layers if the UE detects a SCI format 2-A with Cast type indicator field value of “01”; otherwise, M_{ID} is zero.

A UE determines a m₀ value, for computing a value of cyclic shift α, from a cyclic shift pair index corresponding to a PSFCH resource index and from N^{PSFCH}_{CS} using Table 8.

TABLE 8

| | m₀ | | | | | |
|---|---|---|---|---|---|---|
| | cyclic shift | cyclic shift | cyclic shift | cyclic shift | cyclic shift | cyclic shift |
| | pair index | pair index | pair index | pair index | pair index | pair index |
| N^{PSFCH}_{CS} | 0 | 1 | 2 | 3 | 4 | 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{cs} value, for computing a value of cyclic shift α, as in Table 9 if the UE detects a SCI format 2-A with Cast type indicator field value of “01” or “10”, or as in Table 10 if the UE detects a SCI format 2-B or a SCI format 2-A with Cast type indicator field value of “11”. The UE applies one cyclic shift from a cyclic shift pair to a sequence used for the PSFCH transmission.

TABLE 9

| HARQ-ACK Value | 0 (NACK) | 1 (ACK) |
|---|---|---|
| Sequence cyclic shift | 0 | 6 |

TABLE 10

| HARQ-ACK Value | 0 (NACK) | 1 (ACK) |
|---|---|---|
| Sequence cyclic shift | 0 | N/A |

Meanwhile, a set of (equally spaced) non-contiguous RBs on a frequency may be allocated to a UE. This set of non-contiguous RBs may be referred to as interlaced RBs. This may be useful in spectrum (e.g., shared spectrum) that is subject to regulations such as occupied channel bandwidth (OCB), power spectral density (PSD), etc.

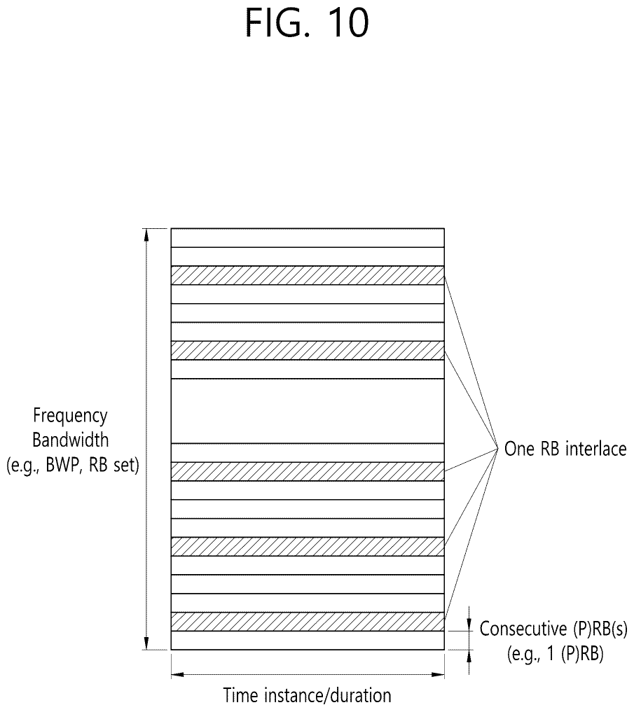

FIG. 10 shows an interlaced RB, based on an embodiment of the present disclosure. The embodiment of FIG. 10 may be combined with various embodiments of the present disclosure.

Referring to FIG. 10, interlaces of RBs may be defined in a frequency domain. An interlace me {0, 1, . . . , M−1} may comprise (common) RBs {m, M+m, 2M+m, 3M+m, . . . }, where M may represent the number of interlaced RBs given by Table 11.

TABLE 11

| u | M |
|---|---|
| 0 | 10 |
| 1 | 5 |

A communication device (e.g., a device, a UE, a vehicle, a drone, etc. proposed in various embodiments of the present disclosure) may transmit a signal/channel by using one or more interlaced RBs.

Meanwhile, in the next-generation system, the UE may perform a sidelink transmission operation and/or a sidelink reception operation in an unlicensed band. Meanwhile, for the operation in the unlicensed band, a channel sensing operation (e.g., energy detection/measurement) for a channel to be used may be performed before the UE performs transmission, depending on band-specific regulations or requirements. Only if the channel or the set of RBs to be used is determined to be IDLE as a result of the channel sensing (e.g., if the measured energy is less than or equal to a specific threshold), the UE may perform transmission in the unlicensed band. If the channel or the RB set to be used is determined to be BUSY as a result of the channel sensing (e.g., if the measured energy is greater than or equal to a specific threshold), the UE may cancel all or part of transmission in the unlicensed band. Meanwhile, in the operation in the unlicensed band, the UE may skip or simplify the channel sensing operation (make a channel sensing interval relatively small) within a certain time after transmission within a specific time duration. On the other hand, after the certain time has passed after the transmission, the UE may determine whether to transmit after performing the usual channel sensing operation. Meanwhile, for transmission in the unlicensed band, power spectral density (PSD) and/or a size of frequency occupation domain and/or a time interval of a signal/channel transmitted by the UE may be greater than or equal to a certain level, respectively, depending on regulations or requirements. Meanwhile, in the unlicensed band, in order to simplify channel sensing, it may be informed through channel occupancy time (COT) duration information that a channel obtained based on initial general channel sensing is occupied for a certain time, and the maximum length of the COT duration may be configured differently depending on a priority value of a data packet or a service.

Meanwhile, a base station may share a COT duration obtained by the base station based on channel sensing through DCI transmission, and the UE may perform a specific (indicated) channel sensing type and/or CP extension within the COT duration based on DCI information received from the base station. Meanwhile, a UE may share a COT duration obtained by the UE based on channel sensing with a base station that is a destination of UL transmission of the UE, and the related information may be provided through UL through configured grant-uplink control information (CG-UCI). In the above situation, the base station may perform simplified channel sensing within the COT duration shared by the UE. In the case of sidelink communication, there is a situation in which a UE receives, from a base station, information on resources to be used for sidelink transmission through DCI or RRC signaling, such as the mode 1 resource allocation (RA) operation, and there is a situation in which a UE performs sidelink transmission and reception through an inter-UE sensing operation without the assistance of the base station, such as the mode 2 RA operation.

Meanwhile, in the case of the channel access type 1, which may be used regardless of the channel occupancy time (COT) configuration, DL transmission may be performed based on the procedure shown in Table 12 and Table 13.

TABLE 12
The eNB/gNB may transmit a transmission after first sensing the channel to be idle during
the sensing slot durations of a defer duration T_{d} and after the counter N is zero in step 4.
The counter N is adjusted by sensing the channel for additional sensing slot duration(s)
according to the steps below:

| | |
|---|---|
| 1) | set N = Nᵢₙᵢₜ, where Nᵢₙᵢₜ is a random number uniformly distributed between 0 and |
| | CWₚ, and go to step 4; |
| 2) | if N > 0 and the eNB/gNB chooses to decrement the counter, set N = N − 1; |
| 3) | sense the channel for an additional sensing slot duration, and if the additional sensing |
| | slot duration is idle, go to step 4; else, go to step 5; |
| 4) | if N = 0, stop; else, go to step 2. |
| 5) | sense the channel until either a busy sensing slot is detected within an additional defer |
| | duration T_{d} or all the sensing slots of the additional defer duration T_{d} are detected |
| | to be idle; |
| 6) | if the channel is sensed to be idle during all the sensing slot durations of the additional |
| | defer duration T_{d}, go to step 4; else, go to step 5; |

If an eNB/gNB has not transmitted a transmission after step 4 in the procedure above, the
eNB/gNB may transmit a transmission on the channel, if the channel is sensed to be idle at
least in a sensing slot duration Tₛₗ when the eNB/gNB is ready to transmit and if the channel
has been sensed to be idle during all the sensing slot durations of a defer duration T_{d}
immediately before this transmission. If the channel has not been sensed to be idle in a
sensing slot duration Tₛₗ when the eNB/gNB first senses the channel after it is ready to
transmit or if the channel has been sensed to be not idle during any of the sensing slot
durations of a defer duration T_{d} immediately before this intended transmission, the
eNB/gNB proceeds to step 1 after sensing the channel to be idle during the sensing slot
durations of a defer duration T_{d}.
The defer duration T_{d} consists of duration T_{f} = 16us immediately followed by mₚ
consecutive sensing slot durations Tₛₗ, and T_{f} includes an idle sensing slot duration Tₛₗ at
start of T_{f}.

TABLE 13
If a gNB transmits transmissions including PDSCH that are associated with channel access
priority class p on a channel, the gNB maintains the contention window value CWₚ and
adjusts CWₚ before step 1 of the procedure described in clause 4.1.1 for those transmissions
using the following steps:

| 1) | For every priority class p ∈ {1,2,3,4}, set CWₚ = CW_{min, p}. | |
|---|---|---|
| 2) | If HARQ-ACK feedback is available after the last update of Wₚ , go to step 3. | |
| | Otherwise, if the gNB transmission after procedure described in clause 4.1.1 does not | |
| | include a retransmission or is transmitted within a duration T_{w} from the end of the | |
| | reference duration corresponding to the earliest DL channel occupancy after the last | |
| | update of CWₚ, go to step 5; otherwise go to step 4. | |
| 3) | The HARQ-ACK feedback(s) corresponding to PDSCH(s) in the reference duration | |
| | for the latest DL channel occupancy for which HARQ-ACK feedback is available is | |
| | used as follows: | |
| | a. | If at least one HARQ-ACK feedback is ‘ACK’ for PDSCH(s) with transport block |
| | | based feedback or at least 10% of HARQ-ACK feedbacks is ‘ACK’ for PDSCH |
| | | CBGs transmitted at least partially on the channel with code block group based |
| | | feedback, go to step 1; otherwise go to step 4. |

| | |
|---|---|
| 4) | Increase CWₚ for every priority class p ∈ {1,2,3,4} to the next higher allowed value. |
| 5) | For every priority class p ∈ {1,2,3,4}, maintain CWₚ as it is; go to step 2. |

The reference duration and duration T_{w} in the procedure above are defined as follows:

| | |
|---|---|
| - | The reference duration corresponding to a channel occupancy initiated by the gNB |
| | including transmission of PDSCH(s) is defined in this clause as a duration starting |
| | from the beginning of the channel occupancy until the end of the first slot where at |
| | least one unicast PDSCH is transmitted over all the resources allocated for the PDSCH, |
| | or until the end of the first transmission burst by the gNB that contains unicast |
| | PDSCH(s) transmitted over all the resources allocated for the PDSCH, whichever |
| | occurs earlier. If the channel occupancy includes a unicast PDSCH, but it does not |
| | include any unicast PDSCH transmitted over all the resources allocated for that |
| | PDSCH, then, the duration of the first transmission burst by the gNB within the |
| | channel occupancy that contains unicast PDSCH(s) is the reference duration for CWS |
| | adjustment. |
| - | T_{w} = max (T_{A}, T_{B} + 1ms) where T_{B} is the duration of the transmission burst from |
| | start of the reference duration in ms and T_{A} = 5ms if the absence of any other |
| | technology sharing the channel can not be guaranteed on a long-term basis (e.g. by |
| | level of regulation), and T_{A} = 10ms otherwise. |

If a gNB transmits transmissions using Type 1 channel access procedures associated with
the channel access priority class p on a channel and the transmissions are not associated
with explicit HARQ-ACK feedbacks by the corresponding UE(s), the gNB adjusts CWₚ
before step 1 in the procedures described in subclase 4.1.1, using the latest CWₚ used for
any DL transmissions on the channel using Type 1 channel access procedures associated
with the channel access priority class p. If the corresponding channel access priority class
p has not been used for any DL transmissions on the channel, CWₚ = CW_{min, p} is used.

Meanwhile, for the channel access type 1, which may be used regardless of the channel occupancy time (COT) configuration. UL transmission may be performed based on the procedure shown in Table 14 to Table 15.

TABLE 14
A UE may transmit the transmission using Type 1 channel access procedure after first
sensing the channel to be idle during the slot durations of a defer duration T_{d}, and after the
counter N is zero in step 4. The counter N is adjusted by sensing the channel for additional
slot duration(s) according to the steps described below.

| | |
|---|---|
| 1) | set N = Nᵢₙᵢₜ, where Nᵢₙᵢₜ is a random number uniformly distributed between 0 and |
| | CWₚ, and go to step 4; |
| 2) | if N > 0 and the UE chooses to decrement the counter, set N = N − 1; |
| 3) | sense the channel for an additional slot duration, and if the additional slot duration is |
| | idle, go to step 4; else, go to step 5; |
| 4) | if N = 0, stop; else, go to step 2. |
| 5) | sense the channel until either a busy slot is detected within an additional defer duration |
| | T_{d} or all the slots of the additional defer duration T_{d} are detected to be idle; |
| 6) | if the channel is sensed to be idle during all the slot durations of the additional defer |
| | duration T_{d}, go to step 4; else, go to step 5; |

If a UE has not transmitted a UL transmission on a channel on which UL transmission(s) are
performed after step 4 in the procedure above, the UE may transmit a transmission on the
channel, if the channel is sensed to be idle at least in a sensing slot duration Tₛₗ when the
UE is ready to transmit the transmission and if the channel has been sensed to be idle during
all the slot durations of a defer duration T_{d} immediately before the transmission. If the
channel has not been sensed to be idle in a sensing slot duration Tₛₗ when the UE first senses
the channel after it is ready to transmit, or if the channel has not been sensed to be idle during
any of the sensing slot durations of a defer duration T_{d} immediately before the intended
transmission, the UE proceeds to step 1 after sensing the channel to be idle during the slot
durations of a defer duration T_{d}.
The defer duration T_{d} consists of duration T_{f} = 16us immediately followed by
mₚ consecutive slot durations where each slot duration is Tₛₗ = 9us, and T_{f} includes an
idle slot duration Tₛₗ at start of T_{f}.

TABLE 15
If a UE transmits transmissions using Type 1 channel access procedures that are associated
with channel access priority class p on a channel, the UE maintains the contention window
value CWₚ and adjusts CWₚ for those transmissions before step 1 of the procedure
described in clause 4.2.1.1, using the following steps:

| 1) | For every priority class p ∈ {1,2,3,4}, set CWₚ = CW_{min, p}; | |
|---|---|---|
| 2) | If HARQ-ACK feedback is available after the last update of CWₚ, go to step 3. | |
| | Otherwise, if the UE transmission after procedure described in clause 4.2.1.1 does not | |
| | include a retransmission or is transmitted within a duration T_{w} from the end of the | |
| | reference duration corresponding to the earliest UL channel occupancy after the last | |
| | update of CWₚ, go to step 5; otherwise go to step 4. | |
| 3) | The HARQ-ACK feedback(s) corresponding to PUSCH(s) in the reference duration | |
| | for the latest UL channel occupancy for which HARQ-ACK feedback is available is | |
| | used as follows: | |
| | a. | If at least one HARQ-ACK feedback is ‘ACK’ for PUSCH(s) with transport block |
| | | (TB) based feedback or at least 10% of HARQ-ACK feedbacks are ‘ACK’ for |
| | | PUSCH CBGs transmitted at least partially on the channel with code block group |
| | | (CBG) based feedback, go to step 1; otherwise go to step 4. |

| | |
|---|---|
| 4) | Increase CWₚ for every priority class p ∈ {1,2,3,4} to the next higher allowed value; |
| 5) | For every priority class p E {1,2,3,4}, maintain CWₚ as it is; go to step 2. |

The HARQ-ACK feedback, reference duration and duration T_{w} in the procedure above
are defined as the following:

| - | For the purpose of contention window adjustment in this clause, HARQ-ACK | |
|---|---|---|
| | feedback for PUSCH(s) transmissions are expected to be provided to UE(s) explicitly | |
| | or implicitly where explicit HARQ-ACK is determined based on the valid HARQ- | |
| | ACK feedback in a corresponding CG-DFI as described in clause 10.5 in [7], and | |
| | implicit HARQ-ACK feedback is determined based on the indication for a new | |
| | transmission or retransmission in the DCI scheduling PUSCH(s) as follows: | |
| | - | If a new transmission is indicated, ‘ACK’ is assumed for the transport blocks or code |
| | | block groups in the corresponding PUSCH(s) for the TB-based and CBG-based |
| | | transmission, respectively. |
| | - | If a retransmission is indicated for TB-based transmissions, ‘NACK’ is assumed for |
| | | the transport blocks in the corresponding PUSCH(s). |
| | - | If a retransmission is indicated for CBG-based transmissions, if a bit value in the |
| | | code block group transmission information (CBGTI) field is ‘0’ or ‘1’ as described |
| | | in clause 5.1.7.2 in [8], ‘ACK’ or ‘NACK’ is assumed for the corresponding CBG in |
| | | the corresponding PUSCH(s), respectively. |

| | |
|---|---|
| - | The reference duration corresponding to a channel occupancy initiated by the UE |
| | including transmission of PUSCH(s) is defined in this clause as a duration starting |
| | from the beginning of the channel occupancy until the end of the first slot where at |
| | least one PUSCH is transmitted over all the resources allocated for the PUSCH, or |
| | until the end of the first transmission burst by the UE that contains PUSCH(s) |
| | transmitted over all the resources allocated for the PUSCH, whichever occurs earlier. |
| | If the channel occupancy includes a PUSCH, but it does not include any PUSCH |
| | transmitted over all the resources allocated for that PUSCH, then, the duration of the |
| | first transmission burst by the UE within the channel occupancy that contains |
| | PUSCH(s) is the reference duration for CWS adjustment. |
| - | T_{w} = max (T_{A}, T_{B} + 1ms) where T_{B} is the duration of the transmission burst from |
| | start of the reference duration in ms and T_{A} = 5ms if the absence of any other |
| | technology sharing the channel cannot be guaranteed on a long-term basis (e.g. by |
| | level of regulation), and T_{A} = 10ms otherwise. |

Meanwhile, the channel access type 2, which is a simplified channel access type, may be used within a channel occupancy time (COT) before transmission, and DL transmission may be performed based on the procedure shown in Table 16.

TABLE 16

| | |
|---|---|
| 4.1.2 | Type 2 DL channel access procedures |

This clause describes channel access procedures to be performed by an eNB/gNB where the
time duration spanned by sensing slots that are sensed to be idle before a downlink
transmission(s) is deterministic.
If an eNB performs Type 2 DL channel access procedures, it follows the procedures
described in clause 4.1.2.1.
Type 2A channel access procedures as described in clause 4.1.2.1 are only applicable to the
following transmission(s) performed by an eNB/gNB:

| | |
|---|---|
| - | Transmission(s) initiated by an eNB including discovery burst and not including |
| | PDSCH where the transmission(s) duration is at most 1ms, or |
| - | Transmission(s) initiated by a gNB with only discovery burst or with discovery burst |
| | multiplexed with non-unicast information, where the transmission(s) duration is at |
| | most 1ms, and the discovery burst duty cycle is at most 1/20, or |
| - | Transmission(s) by an eNB/ gNB following transmission(s) by a UE after a gap of |
| | 25us in a shared channel occupancy as described in clause 4.1.3. |

Type 2B or Type 2C DL channel access procedures as described in clause 4.1.2.2 and 4.1.2.3,
respectively, are applicable to the transmission(s) performed by a gNB following
transmission(s) by a UE after a gap of 16us or up to 16us, respectively, in a shared
channel occupancy as described in clause 4.1.3.

| | |
|---|---|
| 4.1.2.1 | Type 2A DL channel access procedures |

An eNB/gNB may transmit a DL transmission immediately after sensing the channel to be
idle for at least a sensing interval Tₛₕₒᵣₜ_{_{—}}_{dl} = 25us. Tₛₕₒᵣₜ_{_{—}}_{dl} consists of a duration T_{f} =
16us immediately followed by one sensing slot and T_{f} includes a sensing slot at start of
T_{f}. The channel is considered to be idle for Tₛₕₒᵣₜ_{_{—}}_{dl} if both sensing slots of Tₛₕₒᵣₜ_{_{—}}_{dl}
are sensed to be idle.

| | |
|---|---|
| 4.1.2.2 | Type 2B DL channel access procedures |

A gNB may transmit a DL transmission immediately after sensing the channel to be idle
within a duration of T_{f} = 16us. T_{f} includes a sensing slot that occurs within the last 9us
of T_{f}. The channel is considered to be idle within the duration T_{f} if the channel is sensed
to be idle for a total of at least 5us with at least 4us of sensing occurring in the sensing
slot.

| | |
|---|---|
| 4.1.2.3 | Type 2C DL channel access procedures |

When a gNB follows the procedures in this clause for transmission of a DL transmission, the
gNB does not sense the channel before transmission of the DL transmission. The duration of
the corresponding DL transmission is at most 584us.

Meanwhile, the channel access type 2, which is a simplified channel access type, may be used within a channel occupancy time (COT) before transmission, and UL transmission may be performed based on the procedure shown in Table 17.

TABLE 17
4.2.1.2 Type 2 UL channel access procedure
This clause describes channel access procedures by UE where the time duration spanned by
the sensing slots that are sensed to be idle before a UL transmission(s) is deterministic.
If a UE is indicated by an eNB to perform Type 2 UL channel access procedures, the UE
follows the procedures described in clause 4.2.1.2.1.
4.2.1.2.1 Type 2A UL channel access procedure
If a UE is indicated to perform Type 2A UL channel access procedures, the UE uses Type
2A UL channel access procedures for a UL transmission. The UE may transmit the
transmission immediately after sensing the channel to be idle for at least a sensing interval
Tₛₕₒᵣₜ_{_{—}}ᵤₗ = 25us. Tₛₕₒᵣₜ_{_{—}}ᵤₗ consists of a duration T_{f} = 16usimmediately followed by one
sensing slot and T_{f} includes a sensing slot at start of T_{f}. The channel is considered to be idle
for Tₛₕₒᵣₜ_{_{—}}ᵤₗ if both sensing slots of Tₛₕₒᵣₜ_{_{—}}ᵤₗ are sensed to be idle.
4.2.1.2.2 Type 2B UL channel access procedure
If a UE is indicated to perform Type 2B UL channel access procedures, the UE uses Type
2B UL channel access procedure for a UL transmission. The UE may transmit the
transmission immediately after sensing the channel to be idle within a duration of T_{f} =
16us. T_{f} includes a sensing slot that occurs within the last 9us of T_{f}. The channel is
considered to be idle within the duration T_{f} if the channel is sensed to be idle for total of at
least 5us with at least 4us of sensing occurring in the sensing slot.
4.2.1.2.3 Type 2C UL channel access procedure
If a UE is indicated to perform Type 2C UL channel access procedures for a UL transmission,
the UE does not sense the channel before the transmission. The duration of the corresponding
UL transmission is at most 584us.

In an embodiment of the present disclosure, a TYPE 2A SL channel access may be in the same manner as the TYPE 2A DL and/or UL channel access. For example, the TYPE 2A SL channel access may be performed in a sensing interval T_short_sl=25 us, where the interval may consist of a duration T_f=16 us immediately followed by one sensing slot and T_f may include a sensing slot at start of T_f. The basic IDLE determination in the TYPE 2A SL channel access may also borrow IDLE determination from the DL or UL channel access.

In an embodiment of the present disclosure, a TYPE 2B SL channel access may be in the same manner as the TYPE 2B DL and/or UL channel access. For example, in the case of the TYPE 2B SL channel access, the UE may perform transmission immediately after sensing a channel to be idle within a duration of T_f=16 us. T_f may include a sensing slot that occurs within the last 9 us of T_f. The basic IDLE determination in the TYPE 2B SL channel access may also borrow IDLE determination from the DL or UL channel access.

In an embodiment of the present disclosure, a TYPE 2C SL channel access may be in the same manner as the TYPE 2C DL and/or UL channel access. For example, in the case of the TYPE 2C SL channel access, the UE may not perform channel sensing. Instead, the time duration of SL transmission may be at most 584 us.

In an embodiment of the present disclosure, a TYPE 1 SL channel access may be in the same manner as the TYPE 1 DL and/or UL channel access. For example, the UE may randomly derive an integer value N based on a contention window size corresponding to a priority class. Then, if a channel sensing result for a defer duration T_d corresponding to the priority class is idle, the UE may decrease the N−1 counter value in units of T_sl when IDLE. If the value of the counter is zero, the UE may occupy the RB set or the channel subject to channel sensing. If a part of a channel sensing result for the T_sl duration is determined to be busy, the UE may keep the counter value until a channel sensing result for the defer duration T_d is idle, and the UE may continue to perform channel sensing. In the above, the defer duration T_d may consist of T_f=16 us and contiguous m_p*T_sl after T_f=16 us, where m_p may be a value determined by the priority class (p), and T_sl=9 us may be a time interval in which channel sensing is performed.

Hereinafter, a channel access priority class (CAPC) is described.

The CAPCs of MAC CEs and radio bearers may be fixed or configured to operate in FR1:
Fixed to lowest priority for padding buffer status report (BSR) and recommended bit rate MAC CE;
Fixed to highest priority for SRB0, SRB1, SRB3 and other MAC CEs;
Configured by the base station for SRB2 and DRB.

When selecting a CAPC of a DRB, the base station considers fairness between other traffic types and transmissions while considering 5QI of all QOS flows multiplexed to the corresponding DRB. Table 18 shows which CAPC should be used for standardized 5QI, that is, a CAPC to be used for a given QoS flow. For standardized 5QI, CAPCs are defined as shown in the table below, and for non-standardized 5QI, the CAPC with the best QoS characteristics should be used.

TABLE 18

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

NOTE:
A lower CAPC value indicates a higher priority.

Table 19 shows that mₚ, a minimum contention window (CW), a maximum CW, a maximum channel occupancy time (MCOT), and an allowed CW size vary depending on channel access priority classes, in DL.

TABLE 19

| Channel | | | | | | |
|---|---|---|---|---|---|---|
| Access | | | | | | |
| Priority | | | | | | allowed |
| Class (p) | mₚ | CW_{min, p} | CW_{max, p} | T_{mcot, p} | | CWₚ sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

Referring to Table 19, a contention window size (CWS), a maximum COT value, etc. for each CAPC may be defined. For example, T_{d} may be equal to T_{f}+mₚ*Tₛₗ(T_{d}=T_{f}+mₚ*Tₛₗ).

Table 20 shows that mₚ, a minimum contention window (CW), a maximum CW, a maximum channel occupancy time (MCOT), and an allowed CW size vary depending on channel access priority classes, in UL.

TABLE 20

| Channel | | | | | | |
|---|---|---|---|---|---|---|
| Access | | | | | | |
| Priority | | | | | | allowed |
| Class (p) | mₚ | CW_{min, p} | CW_{max, p} | T_{ulmcot, p} | | CWₚ sizes |
| 1 | 2 | 3 | 7 | 2 | ms | {3, 7} |
| 2 | 2 | 7 | 15 | 4 | ms | {7, 15} |
| 3 | 3 | 15 | 1023 | 6 or 10 | ms | {15, 31, 63, 127, |
| | | | | | | 255, 511, 1023} |
| 4 | 7 | 15 | 1023 | 6 or 10 | ms | {15, 31, 63, 127, |
| | | | | | | 255, 511, 1023} |

Referring to Table 20, a contention window size (CWS), a maximum COT value, etc. for each CAPC may be defined. For example, T_{d} may be equal to T_{f}+mₚ*Tₛₗ(T_{d}=T_{f}+mₚ*Tₛₗ).

In an embodiment of the present disclosure, the UE may not be ready to transmit sidelink transmission while the UE has occupied a channel through the TYPE 1 SL channel access. In this case, the UE may configure a defer duration of length T_d and a sensing duration of length T_sl immediately before the sidelink transmission that it is ready to transmit. Herein, if both are idle, the UE may immediately perform the sidelink transmission, but if at least one of the defer duration and the sensing duration is busy, the UE may again perform the TYPE 1 SL channel access. For example, if the sidelink transmission is not possible at a time when channel sensing ends (e.g., if the end of the channel sensing is after the start of the sidelink transmission), the UE may reselect sidelink transmission resource(s). For example, the reselected resource may be selected by considering the end time of the channel sensing and/or the length of the remaining sensing interval, etc. For example, the remaining sensing interval may be a value derived from assuming that all channel sensing is IDLE.

For example, in the present disclosure, a TX UE may be interpreted as: a UE which transmits data (e.g., PSCCH/PSSCH) (to (target) RX UE(s)), and/or a UE which transmits SL CSI-RS (and/or SL CSI report request indicator) (to (target) RX UE(s)), and/or a UE which transmits (pre-defined) RS(s) (e.g., PSSCH DM-RS) to be used for SL (L1) RSRP measurement (and/or SL (L1) RSRP report request indicator) (to (target) RX UE(s)), and/or a UE which transmits a (control) channel (e.g., PSCCH. PSSCH) and/or RS(s) (e.g., DM-RS, CSI-RS) (on the (control) channel) to be used for SL radio link monitoring (RLM) operation (and/or SL radio link failure (RLF) operation) (of (target) RX UE(s)).

For example, in the present disclosure, an RX UE may be interpreted as: a UE which transmits SL HARQ feedback (to the TX UE), based on whether or not decoding of data received from the TX UE succeeds (and/or whether or not detection/decoding of a PSCCH (related to a PSSCH scheduling) transmitted by the TX UE succeeds), and/or a UE which transmits SL CSI (to the TX UE) based on SL CSI-RS(s) (and/or SL CSI report request indicator) received from the TX UE, and/or a UE which transmits a SL (L1) RSRP measurement value (to the TX UE) based on (pre-defined) RS(s) (and/or SL (L1) RSRP report request indicator) received from the TX UE, and/or a UE which transmits its own data (to the TX UE), and/or a UE which performs RLM operation (and/or RLF operation) based on a (pre-configured) (control) channel and/or RS(s) (on the (control) channel) received from the TX UE.

For example, in the present disclosure, the term “PSCCH” may be extended to or interpreted as SCI (and/or first SCI (or second SCI) and/or PSSCH), or vice versa. For example, in the present disclosure, the term “SCI” may be extended to or interpreted as PSCCH (and/or first SCI (or second SCI) and/or PSSCH), or vice versa. For example, in the present disclosure, the term “PSSCH” may be extended to or interpreted as second SCI (and/or PSCCH), or vice versa.

For example, in the present disclosure, the term “configuration/being configured (or definition/being defined)” may be interpreted as being (pre-)configured from a base station (or a network) (through pre-defined signaling (e.g., SIB. MAC. RRC)) (for each resource pool). For example, in the present disclosure, the term “configuration/being configured (or definition/being defined)” may be interpreted as being specified through signaling (e.g., PC5 RRC) pre-defined between UEs. For example, in the present disclosure, the term “RLF” may be extended to or interpreted as out-of-synch (OOS) and/or in-synch (IS), or vice versa. For example, in the present disclosure, the term “RB” may be extended to or interpreted as a subcarrier, or vice versa. For example, in the present disclosure, the term “packet (or traffic)” may be extended to or interpreted as a transport block (TB) (or MAC PDU), or vice versa. For example, in the present disclosure, the term “code block group (CBG) (or CG)” may be extended to or interpreted as a TB, or vice versa. For example, in the present disclosure, the term “source ID” may be extended to or interpreted as “destination ID”, or vice versa. For example, in the present disclosure, the term “L1 ID” may be extended to or interpreted as “L2 ID”, or vice versa. For example, in the present disclosure, the term “retransmission resource reservation/selection” may be extended to or interpreted as reservation/selection of potential retransmission resource(s) in which actual use is determined based on SL HARQ feedback information. For example, in the present disclosure, the term “sub-selection window” may be extended to or interpreted as a selection window (and/or a pre-configured number of resource sets within the selection window), or vice versa. For example, in the present disclosure. “SL mode 1 operation” may refer to a case where a base station directly schedules SL transmission resource(s) for a UE through pre-defined signaling (e.g., DCI), and “SL mode 2 operation” may refer to a case where a UE independently selects SL transmission resource(s) within a resource pool pre-configured (from a base station or a network). For example, in the present disclosure, the term “dynamic grant” may be extended to or interpreted as a configured (or SPS) grant (or a combination of the configured (or SPS) grant and the dynamic grant), or vice versa. For example, in the present disclosure, the term “configured grant” may be extended to or interpreted as “configured grant type 1” (or “configured grant type 2”), or vice versa. For example, in the present disclosure, the term “channel” may be extended to or interpreted as “signal”, or vice versa. For example, in the present disclosure, the term “cast (type)” may be extended to or interpreted as “unicast (and/or groupcast and/or broadcast)”, or vice versa. For example, in the present disclosure, the term “resource” may be extended to or interpreted as “slot” (or “symbol”), or vice versa. For example, in the present disclosure, the term “priority.” may be extended to or interpreted as “logical channel prioritization (LCP)” (and/or “latency” and/or “reliability” and/or “minimum required communication range” and/or “prose per-packet priority (PPPP)” and/or “priority” and/or “SLRB” and/or “QoS profile/parameter” and/or “requirement”), or vice versa. For example, in the present disclosure, the term “UE” may be extended to or interpreted as “base station” (and/or “network”), or vice versa. For example, in the present disclosure, the term “dynamic channel access procedure” may be extended to or interpreted as “LBE” (and/or the term “semi-static channel access procedure” may be extended to or interpreted as “FBE”), or vice versa.

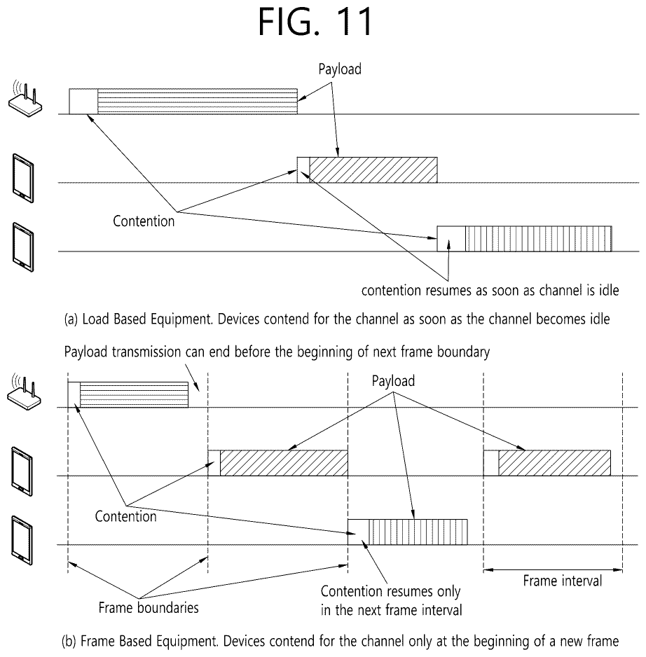

FIG. 11 shows a channel access procedure, based on an embodiment of the present disclosure. Specifically. (a) of FIG. 11 shows an example of a dynamic channel access procedure (load based equipment. LBE), and (b) of FIG. 11 shows an example of a semi-static channel access procedure (frame based equipment. FBE). The embodiment of FIG. 11 may be combined with various embodiments of the present disclosure.

Referring to (a) of FIG. 11, if a channel is idle, the UE may perform contention with other UEs on an unlicensed band to immediately occupy the channel. In addition, if the UE occupies the channel, the UE may transmit data.

Referring to (b) of FIG. 11, the UE may perform contention with other UEs on an unlicensed band at the last time within a synchronized frame boundary (or a fixed frame period (FFP)) (e.g., certain time before the start of the next FFP (or starting time)). In addition, if the UE occupies a channel within the FFP, the UE may transmit data. The data transmission should complete before the next FFP begins. The UE may perform type 2 series LBT operation within the FFP. For example, within the FFP, the UE may not perform random backoff-based LBT, and the UE may sense a channel for a short period of time and perform data transmission if the channel is idle.

Meanwhile, for SL communication on the unlicensed band, if there are the dynamic channel access procedure (e.g., load-based equipment (LBE)) and the semi-static channel access procedure (e.g., frame-based equipment (FBE)), it is unclear which channel access procedure a UE should use under which condition.

Based on various embodiments of the present disclosure, a method for a UE to perform a channel access procedure in an unlicensed band and a device supporting the same are proposed.

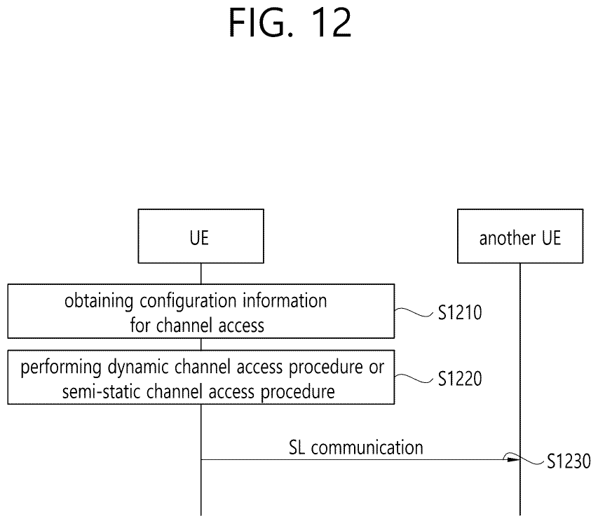

FIG. 12 shows a procedure for a UE to perform sidelink communication based on a dynamic channel access procedure or a semi-static channel access procedure, based on an embodiment of the present disclosure. The embodiment of FIG. 12 may be combined with various embodiments of the present disclosure.

Referring to FIG. 12, in step S1210, the UE may obtain configuration information for channel access. For example, the UE may obtain configuration information related to the dynamic channel access procedure and/or configuration information related to the semi-static channel access procedure. For example, the configuration information may be pre-configured or configured for the UE.

In step S1220, the UE may perform the dynamic channel access procedure or the semi-static channel access procedure.

For example, a switching operation between channel access mechanisms (and/or types) in the unlicensed band (e.g., a switching operation between load-based equipment (LBE) and frame-based equipment (FBE), a switching operation between the dynamic channel access procedure and the semi-static channel access procedure) may be configured to be performed based on (part or all of) the following rules. For example, the UE may be configured to perform a switching operation between channel access mechanisms (and/or types) in the unlicensed band (e.g., a switching operation between LBE and FBE, a switching operation between the dynamic channel access procedure and the semi-static channel access procedure) based on (part or all of) the following rules.

For example, whether to perform the dynamic channel access procedure or the semi-static channel access procedure may be configured differently for each resource pool. For example, whether to perform the dynamic channel access procedure or the semi-static channel access procedure may be configured independently for each resource pool. For example, whether to perform the dynamic channel access procedure or the semi-static channel access procedure may be configured differently for each RB set. For example, whether to perform the dynamic channel access procedure or the semi-static channel access procedure may be configured independently for each RB set. For example, whether to perform the dynamic channel access procedure or the semi-static channel access procedure may be configured differently for each carrier. For example, whether to perform the dynamic channel access procedure or the semi-static channel access procedure may be configured independently for each carrier.

For example, if the semi-static channel access procedure (and/or the dynamic channel access procedure) is indicated from the base station through higher layer signaling (e.g., MAC CE, RRC, SIB) (and/or physical layer signaling (e.g., DCI)), the UE may perform a channel access procedure based on the semi-static channel access procedure (and/or the dynamic channel access procedure).

For example, if the semi-static channel access procedure (and/or the dynamic channel access procedure) is indicated from a (pre-) configuration, the UE may perform a channel access procedure based on the semi-static channel access procedure (and/or the dynamic channel access procedure).

For example, if the semi-static channel access procedure (and/or the dynamic channel access procedure) is indicated from another UE through PC5-RRC signaling (and/or MAC CE and/or SCI and/or PC5-S signaling), the UE may perform a channel access procedure based on the semi-static channel access procedure (and/or the dynamic channel access procedure). For example, if the semi-static channel access procedure (and/or the dynamic channel access procedure) is indicated from a pre-configured entity (e.g., an RSU) through PC5-RRC signaling (and/or MAC CE and/or SCI and/or PC5-S signaling), the UE may perform a channel access procedure based on the semi-static channel access procedure (and/or the dynamic channel access procedure).

For example, the UE may be configured to determine whether to perform the dynamic channel access procedure or the semi-static channel access procedure based on location information of the UE (and/or (measured) congestion level information and/or information on whether another (or the same) RAT (e.g., Wi-Fi) (channel/signal) is detected). For example, if the location of the UE is within the (pre-configured) area, the UE may perform a channel access procedure based on the semi-static channel access procedure. For example, if the location of the UE is not available and/or the reliability of the location-related measurement is determined to be less than or equal to a certain level, the UE may perform a dynamic channel access procedure, and/or the UE may deactivate the sidelink communication (SL-U) operation (and/or SL BWP) on the unlicensed band.

For example, the UE may determine whether to perform the dynamic channel access procedure or the semi-static channel access procedure based on information indicated in the received S-SSB (e.g., S-PSS, S-SSS, PSBCH).

In step S1230, the UE may perform SL communication based on the channel access procedure.

For example, the UE may be configured to perform SL communication on the unlicensed band based on (part or all of) the following rules.

### 1. SL BWP and SL Resource Pool Configuration

In NR-U. BWP is configured to be aligned with RB set(s) in boundaries. Moreover, according to the agreement made in RANI #109-e meeting, a SL resource pool can be (pre)configured to include integer number of RB sets. From those of points of view, it would be necessary that the SL BWP is also (pre)configured to be aligned with RB set(s) in boundaries.

Considering that the BWP in NR-U is always aligned with RB set(s) in boundaries, the benefit of supporting a SL resource pool including a subset of PRBs of one RB set is unclear. Moreover, considering that the granularity of the channel sensing operation is an RB set, it would be better in terms of resource utilization not to restrict available resource into a certain subset of resources in the RB set. In Rel-16, since the granularity of the number of frequency resources belonging to a SL resource pool is a PRB, there is no problem to align the boundary of the SL resource pool with the boundary of RB set(s).

Depending on the regulation, the occupied bandwidth would need to be larger than 80% over the total bandwidth. Moreover, power spectral density for any 1 MHz could be limited. In NR-U, to meet these regulations, interlaced RB-based transmission is supported. In RANI #109-e meeting, it is agreed that at least for PSCCH and PSSCH, both NR SL contiguous RB-based and interlaced RB-based transmissions are considered. In this case, it is necessary to decide the granularity of (pre) configuration to enable or disable the interlaced RB-based transmission. In NR-U, the interlaced RB-based transmission is a part of UE capability, and enabling/disabling interlaced RB-based transmission is cell-specific. Meanwhile, if the interlaced RB-based transmission is (pre)configured per SL BWP or SL carrier, then UE(s) without the interlaced RB-based TX capability would not be supported on the SL carrier. In our view: since S-SSB transmission is still a form of interlaced structure, the benefit of allowing the coexistence between contiguous RB-based transmission and interlaced RB-based transmission in a SL carrier would be unclear. To be specific, even if the contiguous RB-based transmission is allowed in a SL carrier with OCB requirement, the UEs without interlaced RB-based transmission capability cannot transmit S-SSB transmission.

If S-SSB transmission is a form of interlace structure, the benefit of the coexistence between contiguous RB-based transmission and interlaced RB-based transmission in a SL carrier is unclear.

For example, for SL BWP configuration on shared spectrum, starting PRB of SL BWP is aligned with the lowest PRB of the lowest RB set within SL BWP, and/or ending PRB of SL BWP is aligned with the highest PRB of the highest RB set within SL BWP, and/or either contiguous RB-based transmission or interlaced RB-based transmission is (pre)configured.

For example, for SL resource pool configuration in frequency domain on shared spectrum, starting PRB (i.e., sl-StartRB-Subchannel) is aligned with the lowest PRB of the lowest RB set within the resource pool, and/or the number of PRBs (i.e., sl-RB-Number) is set so that the ending PRB is aligned with the highest PRB of the highest RB set within the resource pool.

In the case of SL communication on licensed spectrum, for TDD, cell-specific UL slots can belong to a resource pool. For flexible slots, if the SL symbol group in a slot is set to cell-specific UL, then the flexible slots can belong to a resource pool as well. For simplicity, even for unlicensed spectrum operation, the same principle could be adopted for candidate slots that can belong to a resource pool. If it is allowed for other flexible slots or DL slots to belong to a resource pool, it would be further discussed how to define the prioritization rule between DL reception (e.g., DL discovery burst. PDCCH monitoring. CSI measurement) and SL transmission/reception. If the UE is configured with tdd-UL-DL-ConfigurationCommon for the unlicensed carrier, it seems straightforward to use it as in Rel-16/17 NR SL.

For example, for SL communication on shared spectrum, a resource pool excludes the following slots:
Slots whose symbols from sl-StartSymbol to sl-StartSymbol+sl-LengthSymbols−1 are not semi-statically configured as UL as per the higher layer parameter tdd-UL-DL-ConfigurationCommon of the serving cell if provided or sl-TDD-Configuration if provided or sl-TDD-Config of the received PSBCH if provided
S-SSB slots
Reserved slot as specified in section 8 of TS 38.214

### 1.1. Contiguous RB-Based Transmission

According to NR-U, the granularity of channel sensing operation is RB set, and the size of the RB set is between 100 and 110 for 15 kHz SCS or between 50 and 55 except for at most one RB set which may contain 56 RBs for 30 kHz SCS. Moreover, depending on the carrier, there could exist guard-band between two adjacent RB sets. If UE accesses two RB sets, then the UE can transmit UL channel/signal on resources belonging to guard bands as well to ensure contiguous UL transmission in frequency domain.

For contiguous RB-based PSCCH/PSSCH transmission, since the granularity of PSCCH/PSSCH transmission is sub-channel, it would be necessary to investigate the relationship between RB sets and sub-channels. If Rel-16 NR SL sub-channelization is applied to the multiple RB sets, sub-channels would not be aligned with RB sets in boundaries. In this case, it would be possible that a subset of PRBs belonging to a sub-channel is outside the RB set, and these PRBs would not be used for PSCCH/PSSCH transmissions.

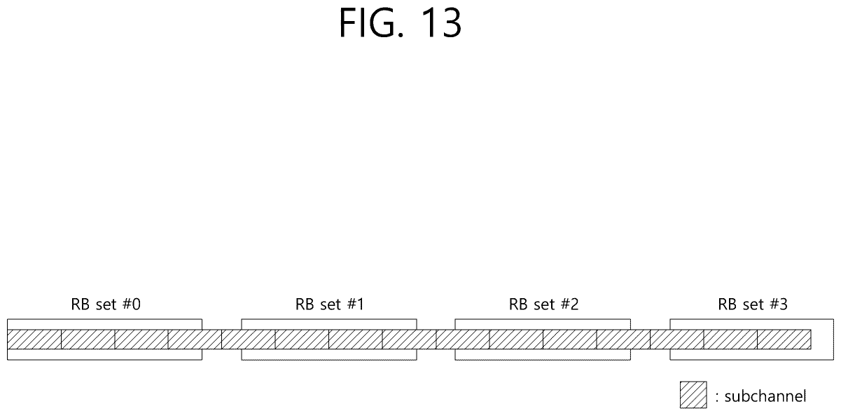

FIG. 13 shows an example of sub-channelization for contiguous RB-based PSCCH/PSSCH transmission, based on an embodiment of the present disclosure. The embodiment of FIG. 13 may be combined with various embodiments of the present disclosure.

For instance, in FIG. 13, only two sub-channels are fully confined within RB set #1, and the parts of the other sub-channels are outside the RB set. In this case, when UE transmits PSCCH/PSSCH on RB set #1, then the only two sub-channels can be used. In this case, a number of resources within the RB set cannot be utilized. Moreover, for 60 KHz SCS, if the contiguous RB-based PSCCH/PSSCH transmission is used, the OCB requirement would not be fulfilled especially when the sub-channels overlapping with guard band or another RB set are not used.

If sub-channels are not aligned with RB sets in boundaries, a number of resources within an RB set would not be utilized especially for single RB set transmission.

For 60 KHz SCS, contiguous RB-transmission may or may not fulfill the OCB requirements especially when the truncated sub-channel is not used for PSCCH/PSSCH transmission.

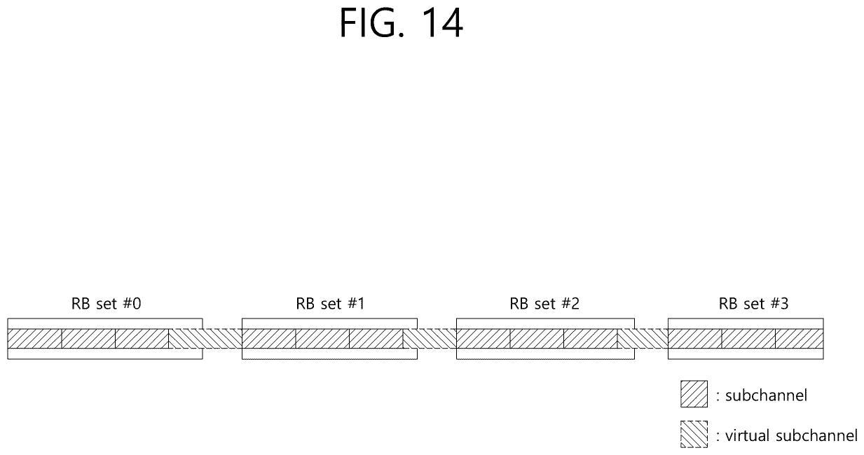

Alternatively, sub-channels could be defined to be aligned with RB set(s) in boundaries. To be specific, for each RB set belonging to a SL resource pool, sub-channels can be allocated to be fully confined within the RB sets as shown in FIG. 14.

FIG. 14 shows an example of sub-channelization for contiguous RB-based PSCCH/PSSCH transmission, based on an embodiment of the present disclosure. The embodiment of FIG. 14 may be combined with various embodiments of the present disclosure.

Meanwhile, the remaining PRBs after allocating the sub-channel of each RB set and PRBs belonging to a guard band can be automatically used for PSCCH/PSSCH transmission only if the adjacent RB sets are allocated for PSCCH/PSSCH transmission. Moreover, to ensure enabling the same TB size regardless of whether or not to use these remaining PRBs, it can be considered that the remaining PRBs are not counted for TBS determination.

For example, for contiguous RB-based transmission, sub-channels are defined to be aligned with RB set(s) in boundaries, and/or PRBs between sub-channels belonging to different RB sets can be used automatically for PSCCH/PSSCH transmission when the sub-channels belonging to different RB sets are used for the PSCCH/PSSCH transmission, and/or PRBs not belonging to a sub-channel is not counted for TBS determination.

### 1.2. Interlaced RB-Based Transmission

In RANI #109-e meeting, it is agreed that at least for PSCCH and PSSCH, interlaced RB-based transmissions are considered. Since the granularity of PSCCH/PSSCH scheduling is a sub-channel, it would be necessary to discuss how to define sub-channel for the RB-based interlace structure. Or, it would be necessary to modify FRIV indication to indicate RB set(s) and/or interlace index for the current resource and the reserved resources.

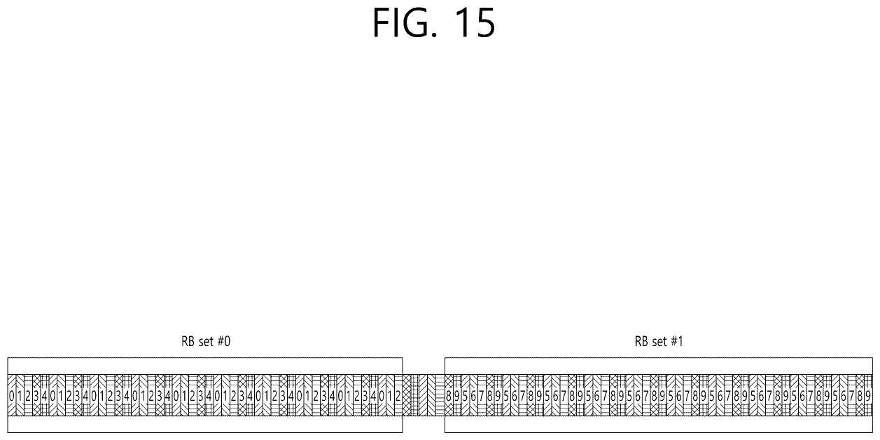

FIG. 15 shows an example of sub-channelization for interlaced RB-based PSCCH/PSSCH transmission, based on an embodiment of the present disclosure. The embodiment of FIG. 15 may be combined with various embodiments of the present disclosure.

First of all, a sub-channel can consist of PRBs belonging to one or multiple interlaces within an RB set. In this case, it can be considered that sub-channel indexing is done in increasing order of first the interlace index, and then the RB set index as shown in FIG. 15. In this case, the UE can use multiple interlaces within an RB set by using the existing contiguous sub-channel allocation indicator, and it would be beneficial in terms of channel availability. However, if the UE uses more than one RB sets for PSCCH/PSSCH transmission, it would not guarantee that the same set of interlaces is used. In this case. PAPR for PSCCH/PSSCH transmission over multiple RB sets would be increased further. Since the same set of interlace index(es) over different RB sets is assumed in NR-U PUSCH, if it is allowed to support a different set of interlace index(es) over different RB sets in SL-U. RAN4 specification work will be additionally needed. Moreover, considering the PSD requirement, if the unequal number of interlace index(es) over different RB sets is allowed as in this approach, total transmit power of PSCCH/PSSCH will be limited. For instance, for 30 KHz SCS, if 5 interlaces are used for the 1^{st} RB set and 1 interlace is used for the 2^{nd} RB set, and if the PSD requirement is 10 dBm/1 MHZ, the maximum transmit power will be limited to 13 dBm. On the other hand, if 3 distributed interlaces over the 1^{st} and 2^{nd} RB sets are used instead, the maximum transmit power will be increased to 21 dBm. Due to the reduced transmit power, the applicable scenario of SL-U will be restricted.

Moreover, as per agreement, when a UE uses PRBs within the intra-cell guard band of two adjacent RB sets for SL transmission, it would be more complicated which interlace will be used in the guard band if a different set of interlace index(es) over different RB sets is allowed.

If a subchannel consists of PRBs corresponding to an interlace index within an RB set, and if the subchannel indexing is done in increasing order of first the interlace index, and then the RB set index, and if more than one RB set is scheduled for PSSCH transmission, the same set of interlaces across different RB sets would not be guaranteed. It will cause additional RAN4 specification work, limitation on applicable scenario due to reduced transmit power, and high PAPR.

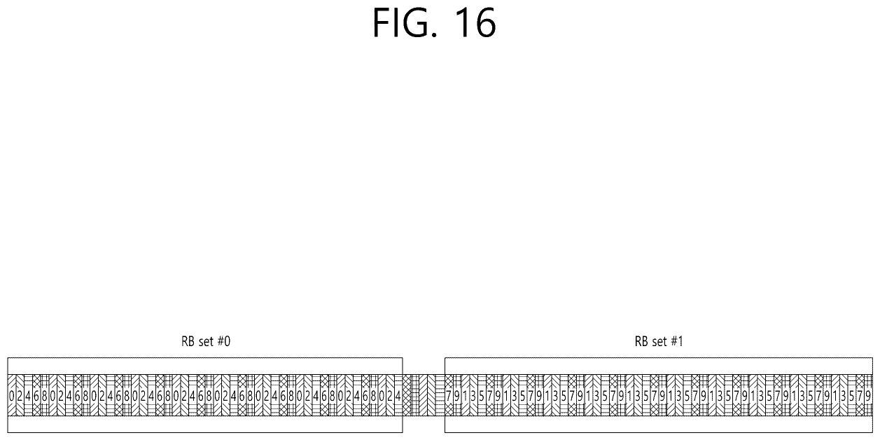

FIG. 16 shows an example of sub-channelization for interlaced RB-based PSCCH/PSSCH transmission, based on an embodiment of the present disclosure. The embodiment of FIG. 16 may be combined with various embodiments of the present disclosure.

Alternatively, sub-channel indexing can be done in increasing order of first the RB set index, and then the interlace index as shown in FIG. 16. In this case, when the UE uses more than one RB set for PSCCH/PSSCH transmission, the same set of interlaces could be guaranteed. However, in this approach, even though the number of sub-channels is small, multiple RB sets will be used, and it would not be good in terms of channel availability.

If a subchannel consists of PRBs corresponding to an interlace index within an RB set, and if the subchannel indexing is done in increasing order of first the RB set index, and then the interlace index, and if more than one interlace is scheduled for PSSCH transmission, it may be necessary to use multiple RB sets for PSSCH transmission. In this case, the UE needs to access both RB sets for a PSSCH transmission.

Meanwhile, considering the PSD requirement, it would be necessary to support the distributed mapping of PSSCH transmission as shown in FIG. 16. For instance, when a UE uses sub-channel #0 and sub-channel #1 for a PSSCH transmission, according to the PSD requirement. 10 dBm will be distributed into a PRB of subchannel #0 and a PRB of subchannel #1 in FIG. 15 while 10 dBm will be allocated to both a PRB of subchannel #0 and a PRB of sub-channel #1 in FIG. 16. In the above example, the mapping of FIG. 16 can use twice as much TX power as the mapping of FIG. 15.

Due to the PSD requirement (e.g., 10 dBm/MHz), depending on the number of interlaces, it would be useful to use multiple RB sets rather than to use single RB set for PSSCH transmission for the same number of PRBs or interlaces.

If a contiguous sub-channel allocation indicator is reused for interlaced RB-based PSSCH transmission, depending on the sub-channelization method, the resource allocation could be inefficient in terms of channel accessibility. PAPR, and/or TX power restriction.

Since the sub-channelization without a separate indication of allocated RB set(s) will lose scheduling flexibility, it would be better to consider indicating RB set(s) separately from indicating interlace(s) or sub-channel(s). In this case, a single sub-channel can consist of PRBs belonging to a single or multiple interlaces across RB set(s). The final PRBs allocated for PSSCH transmission will be determined by the intersection between the indicated sub-channel(s) and the indicated RB set(s) like NR-U resource allocation type 2. Since it would be necessary to consider how to indicate reserved resources in NR SL. FRIV can be used to indicate RB set(s) instead of RIV. In this approach, we can maximize the scheduling flexibility and can guarantee the same set of interlaces across different RB sets when more than one RB set is used for PSSCH transmission.

For example, for interlaced RB-based PSSCH transmission, support explicitly indicating the used sub-channel index(es) and RB set index(es) (Option 1). SCI indicates FRIV for subchannel allocation and FRIV for RB set allocation. Subchannel indexing is done in increasing order of the interlace index. PSSCH transmission resource(s) are determined by the intersection of indicated sub-channel(s) and indicated RB set(s).

### 2. Time Domain Resource Assignment for PSCCH/PSSCH on Shared Spectrum

2.1. Additional Starting Symbol(s) within a Slot

In RANI #110bis-e meeting, it was agreed to introduce an additional starting symbol within a slot for PSCCH/PSSCH transmission to mitigate LBT failure as working assumption. Meanwhile, even for the single starting symbol within a slot for PSCCH/PSSCH transmission, which is already agreed, it is necessary to decide how to set the starting symbol position for PSCCH/PSSCH transmission. Considering multi-consecutive slots transmission for skipping channel sensing operation in the middle of the transmission, it would be better to always fix the starting symbol index into 0). However, considering coexistence with NR-U and forward compatibility, it can be considered to set the starting symbol index based on the (pre)configured parameter as in Rel-16/17 NR SL. In our understanding, even though the starting symbol index is (pre)configured, it also allows the possibility of setting the value into 0).

For example, for starting symbols within a slot for a PSCCH/PSSCH transmission, the 1^{st} starting symbol index is M1. M1 is indicated by sl-StartSymbol as in R16 NR SL. The 2^{nd} starting symbol index is M2. M2 is (pre)configured in a resource pool so that M2>M1. A single ending symbol index is used in a slot as in R16 NR SL.

On multiple starting positions of slot-based PSCCH/PSSCH transmission, when the UE fails to access a channel before the earlier starting position, then the UE attempts to access the channel for the next starting position for a PSCCH/PSSCH transmission. When the UE prepares the PSCCH/PSSCH transmission with a later starting position after determining LBT failure for the earlier starting position, the processing time budget would not be sufficient.

Alternatively, it can be considered that the UE prepares multiple OFDM waveforms for multiple starting positions in advance. However, in this case, the UE needs to have sufficient storage to store multiple waveforms with multiple starting positions. Even for this case, it is necessary to have sufficient processing time budget for switching to proper waveforms. To alleviate these problems, it can be considered that the time gap between the 1^{st} starting position and the 2^{nd} starting position is sufficiently large to accommodate the processing time budget for re-encoding.

Moreover, it is necessary to check whether or how to ensure enabling the same TB size among PSSCH transmission candidates with different starting positions. For TBS determination, if the TBS is determined based on the 1^{st} starting position, the effective code rate of the PSSCH transmission with the 2^{nd} starting position could be too high. In this case, the UE still needs to transmit retransmission for the same TB. If the TBS is determined based on the 2^{nd} starting position, the peak data rate will be limited.

For example, for multiple starting symbols within a slot for a PSCCH/PSSCH transmission. TBS is determined based on the PSCCH/PSSCH with the 1^{st} starting symbol index.

Since PSCCH transmission will be confined within the PSSCH transmission, if more than one starting position is allowed, the PSCCH transmission candidates would also be increased. In this case, the PSSCH RX UE needs to perform blind decoding for multiple starting positions. Once multiple starting symbols in a slot for a PSCCH/PSSCH transmission are supported, the UE should be capable of performing blind decoding for multiple starting symbols as well. It was discussed the possibility that the UE skips blind decoding for PSCCH with the 2^{nd} starting symbol when the UE succeeds to detect PSCCH on the 1^{st} starting symbol. However, it will have a negative impact on the SL sensing operation. Due to the hidden-node issue, it is possible that two different PSCCH/PSSCH transmissions with different starting symbols are overlapping in the same slot. Since each PSCCH will contain SCI indicating reserved resources, it would be beneficial for the UE to decode both PSCCHs with different starting symbols for SL Mode 2 operation.

The UE monitors PSCCHs on two starting symbols within a slot where 2 candidate starting symbols within a slot for a PSCCH/PSSCH transmission are supported regardless of detection of PSCCH on the 1^{st} starting symbol.

As per the working assumption, the PSSCH RX UE will perform an additional AGC procedure for the 2^{nd} starting position since PSCCH/PSSCH transmission with different starting positions can be FDMed from a system perspective. Since these additional AGC symbols would not be used for decoding or channel estimation, the throughput performance would also be degraded. In Rel-16/17 NR SL, REs used for the PSSCH in the second OFDM symbol are duplicated in the AGC symbol. However, the AGC procedure itself is RX UE behavior, and it does not always imply such duplication shall be used as TX UE behavior.

Candidate starting symbol(s) intended for AGC purpose does not imply that REs on other symbols will be duplicated in the AGC symbol.

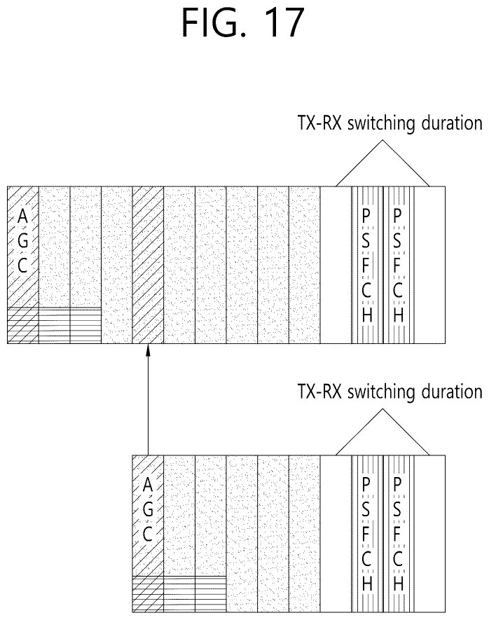

To alleviate performance degradation due to an additional AGC procedure at the additional starting position, it is necessary to decide which symbol needs to be avoided or selected as the additional starting symbol. First of all, in a resource pool with PSFCH resources, both starting symbols need to guarantee the existence of PSFCH resources at least in a PSFCH occasion as shown in FIG. 17.

FIG. 17 shows an example of an additional starting position of PSCCH/PSSCH to ensure PSFCH resources in the same slot. The embodiment of FIG. 17 may be combined with various embodiments of the present disclosure.

Note that PSSCH duration including an AGC symbol needs to be greater than or equal to 6 to have PSFCH resources in the same slot. Otherwise, PSFCH resources for the 1^{st} starting symbol will collide with PSCCH/PSSCH with the 2^{nd} starting symbol. Alternatively, it can be considered that the additional starting symbol of PSCCH/PSSCH is not allowed in slot(s) with PSFCH resources.

For a PSFCH slot, both candidate starting symbols need to guarantee the existence of PSFCH resources. Alternatively, an additional starting symbol will not be allowed in a PSFCH slot

Next, at least PSCCH symbol duration of PSCCH/PSSCH with the 1^{st} starting symbol needs to be avoided to be the 2^{nd} starting symbol to guarantee PSCCH detection performance. If the 2^{nd} starting symbol is overlapping with PSCCH symbol duration of PSCCH/PSSCH with the 1^{st} starting position as shown in FIG. 18, the RX UE can effectively use only one symbol for PSCCH decoding.

FIG. 18 shows an example of an additional starting position of PSCCH/PSSCH overlapping with PSCCH symbol duration of PSCCH/PSSCH with the 1^{st} starting position, based on an embodiment of the present disclosure. The embodiment of FIG. 18 may be combined with various embodiments of the present disclosure.

The 2^{nd} starting symbol of PSCCH/PSSCH is not overlapping with PSCCH symbol duration for the 1^{st} starting symbol of PSCCH/PSSCH to guarantee PSCCH detection performance.

In a similar manner, the 2^{nd} starting symbol needs to avoid the time location(s) for the 2^{nd} SCI of PSCCH/PSSCH with the 1^{st} starting position. To do this, the 2^{nd} starting position would be located later than the upper limit of the 2^{nd} SCI mapping. Alternatively, a beta offset indicator needs to be adjusted to ensure that the 2^{nd} SCI mapping of PSCCH/PSSCH with the 1^{st} starting position is not overlapping with the 2^{nd} starting position.

It is necessary to carefully investigate whether or how the 2^{nd} starting symbol of PSCCH/PSSCH is overlapping with the time location(s) for the 2^{nd} SCI mapping for the 1^{st} starting symbol of PSCCH/PSSCH.

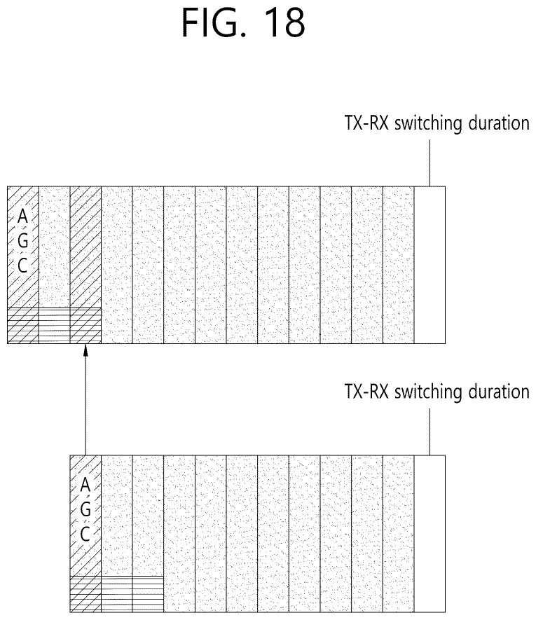

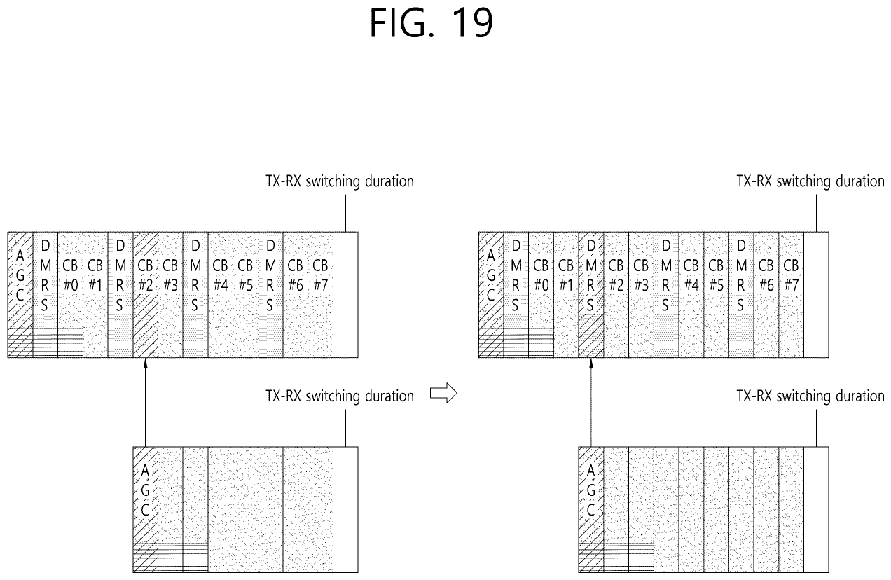

Considering channel estimation performance for 2^{nd} SCI and PSSCH, it would be better to avoid possible time location(s) of PSSCH DMRS for the 1^{st} starting symbol. However, if the 2^{nd} starting symbol is always overlapping with the data symbol of PSSCH with the 1^{st} starting symbol, the RX UE will fail to decode certain code block(s) mapped on the data symbol as shown in FIG. 19.

FIG. 19 shows an example of an additional starting position of PSCCH/PSSCH overlapping with or without a PSSCH DMRS symbol of PSCCH/PSSCH with the 1^{st} starting position, based on an embodiment of the present disclosure. The embodiment of FIG. 19 may be combined with various embodiments of the present disclosure. Since NR SL does not support CBG-based retransmission, the TX UE may need to retransmit the whole TB until all the code blocks are not skipped due to additional AGC procedure. For instance, if the TX UE transmits PSCCH/PSSCH with the 1^{st} starting symbol, the TX UE still needs to retransmit the PSCCH/PSSCH with different starting symbol and/or PSSCH DMRS pattern and/or beta offset to recover the punctured code block. To avoid this situation, it can be considered that the 2^{nd} starting symbol can be overlapping with a certain PSSCH DMRS symbol of PSCCH/PSSCH with the 1^{st} starting symbol as shown in FIG. 19. If the number of PSSCH DMRS symbols is large enough, performance degradation on channel estimation due to puncturing a PSSCH DMRS symbol would be marginal. For instance, if the 1^{st} starting symbol index of PSCCH/PSSCH is 0), and if the number of SL symbols in a slot is 14, and if the number of PSSCH DMRS symbols can be 2 or 4 in the resource pool, the 2^{nd} starting symbol of PSCCH/PSSCH could be set to OFDM symbol index 4 which is the second DMRS symbol position for the 1^{st} starting symbol. If the TX UE determines that the additional AGC procedure can be performed in the data symbol, the TX UE will select the number of PSSCH DMRS symbols as 2 for the 1^{st} starting symbol. On the other hand, if the TX UE determines that the additional AGC procedure needs to be performed to avoid the data symbol, the TX UE will select the number of PSSCH DMRS symbols as 4 for the 1^{st} starting symbol.

Considering that a certain code block(s) can be consistently dropped, it can be considered that the 2^{nd} starting symbol of PSCCH/PSSCH is set to the PSSCH DMRS symbol index of a certain DMRS pattern for PSCCH/PSSCH with the 1^{st} starting symbol.

For example, for multiple starting symbols within a slot for a PSCCH/PSSCH transmission, the 2^{nd} starting symbol is selected to be overlapping with the 2^{nd}_{PSSCH} DMRS symbol of a DMRS pattern with more than 2 DMRS symbols (pre)configured for PSCCH/PSSCH with the 1^{st} starting symbol in a resource pool.

### 2.2. SL Transmission Burst Structure

To minimize overhead for channel sensing operation, it can be considered to introduce SL burst transmission for the same TB and/or different TBs. According to TS 37.213 V17.3.0, for burst transmission, the gNB or the UE can skip LBT operation for consecutive DL or UL transmissions without gaps after the gNB or the UE accesses the channel according to the channel access procedure, respectively.

Meanwhile, according to the SL slot structure, the last SL symbol is used for TX-RX switching period, and any SL channels/signals are not mapped on the last SL symbol. In this case, at least for SL burst transmission, it would be necessary to define how to reduce or remove TX-RX switching period in a SL slot. One simple way is that whether or not to use the last SL symbol for SL transmission is implicitly or explicitly indicated by the PSCCH/PSSCH TX UE.

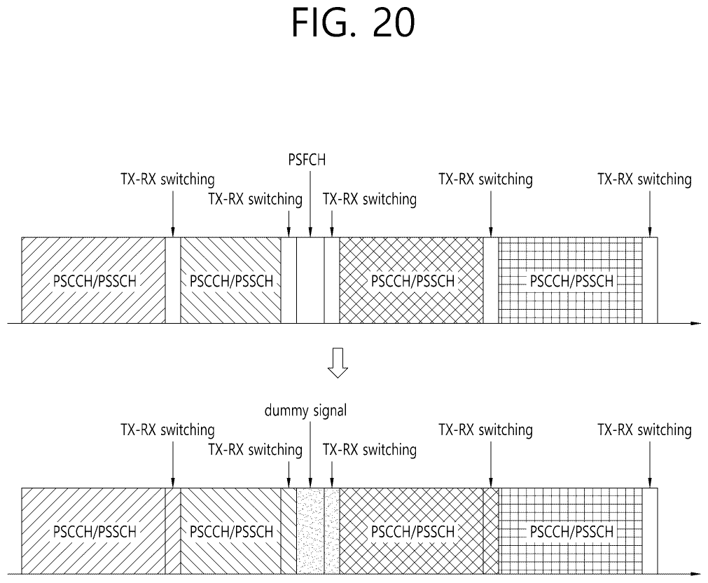

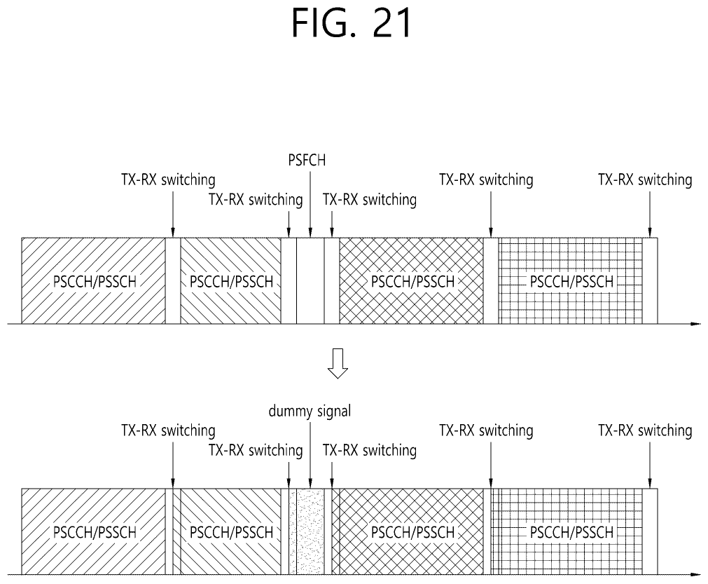

FIG. 20 or FIG. 21 shows an example of SL burst transmission, based on an embodiment of the present disclosure. The embodiment of FIG. 20 or FIG. 21 may be combined with various embodiments of the present disclosure.

In this case, the TX UE will perform rate-matching for the last SL symbol as shown in FIG. 20. However, in this approach, since the PSSCH symbol duration will be changed, it would be necessary to update or newly define a PSSCH DMRS pattern for the increased PSSCH symbol duration. Moreover, since the number of available REs will increase, it may also have an impact on the TBS determination. To be specific, especially when initial transmission and retransmission differently use the last SL symbol, it would not be guaranteed to enable the same TBS between initial transmission and retransmission.

Another approach is to perform CP extension to use all or a subset of a TX-RX switching symbol of the earlier SL transmission of the TX UE as shown in FIG. 21.

For SL transmission burst, the time gap between adjacent PSCCH/PSSCH transmissions is not greater than 16 usec by applying CPE to the later PSCCH/PSSCH transmission.

In the SL slot structure, a PSFCH resource is TDMed with a PSCCH/PSSCH resource within a slot, and the maximum PSFCH resource period is 4 logical slots. In this case, the maximum duration of SL burst transmission would also be limited to 4 slots. To extend the time duration of the SL burst transmission, one way is to increase the maximum PSFCH resource period. Alternatively, it can be considered that the TX UE transmits any signal in a PSFCH occasion to ensure the time gap between transmission(s) is no greater than 16 usec. For SL transmission burst, down-select one or more of the following:
Option 1: Maximum size of SL transmission burst is determined by the PSFCH resource period.
Option 2: PSSCH TX UE can transmit any signal in a PSFCH occasion to ensure the time gaps between transmissions within a SL transmission burst are no greater than 16 usec.

### 3. SL HARQ Procedure

In RANI #109-e meeting, it was discussed that the possibility of introducing a new PSFCH format and/or introducing multiple chances of PSFCH transmission in response to a PSSCH transmission.

Unlike Uu link, a TX UE can transmit PSSCH transmissions to different RX UEs, and then the TX UE can receive a number of SL HARQ-ACK feedbacks from different RX UEs. In this case, each RX UE will transmit one SL HARQ-ACK information to the same TX UE. In this case, rather than a new PSFCH format with a large payload size, the existing PSFCH format 0 is sufficient for the container of the SL HARQ-ACK feedback. Moreover, since a new PSFCH format with a large payload size would have no or small multiplexing capacity, the overall PSFCH resource overhead would be too large. In those points of view; it is not preferable to support non-numerical HARQ FB and one shot HARQ FB. Moreover, it is unclear how to use it for LS HARQ-ACK feedback in response to groupcast PSCCH/PSSCH.

Since the PSSCH TX UE can receive a number of SL HARQ-ACK feedbacks from different PSSCH RX UEs, the R16 NR SL PSFCH format 0 is sufficient for the container of the SL HARQ-ACK feedback. In this case, it is not preferable to support non-numerical HARQ FB and one shot HARQ FB.

In Rel-16 PSSCH-to-PSFCH mapping, the implicit mapping rule is adopted rather than dynamic indication of PSFCH resources. It is motivated from the fact that if the dynamic indication is adopted, the PSSCH TX UE needs to perform sensing operation for PSFCH further. Since the SL HARQ-ACK enabling/disabling and SL-HARQ-ACK feedback option indicators are present in the 2^{nd} SCI, the TX UE would need to succeed to decode the 2^{nd} SCI of other UEs as well for sensing operation. If the TX UE does not perform such sensing operation for PSFCH, even though PSSCH resource collision does not occur, the PSFCH resource collision can occur. It was discussed the possibility that the PSCCH/PSSCH TX UE indicates the PSFCH resource to be inside the shared COT duration. However, since the existing PSSCH-to-PSFCH mapping already targets the case where the PSCCH/PSSCH RX UE transmits PSFCH as soon as possible upon PSCCH/PSSCH reception, it is still unclear the necessity of dynamic indication. If the dynamic indication targets to indicate the PSFCH resource inside the COT duration in the future, it is also ambiguous since the future COT duration would not always be guaranteed.

If the locations of PSFCH resources are dynamically indicated, the UE needs to perform sensing operation for PSFCH further. Otherwise, even though PSSCH resources are not overlapping each other, the PSFCH resource collision can occur.

For the PSFCH resource inside the current COT duration, it seems to be enough to use the existing implicit PSSCH-to-PSFCH mapping since the existing mapping rule targets the case when the RX UE transmits PSFCH as soon as possible upon PSCCH/PSSCH reception.

For dynamic indication of the PSFCH resource to be inside the future COT duration, since the future COT duration is not always guaranteed, it is unclear whether it can mitigate PSFCH transmission dropping due to LBT failure.

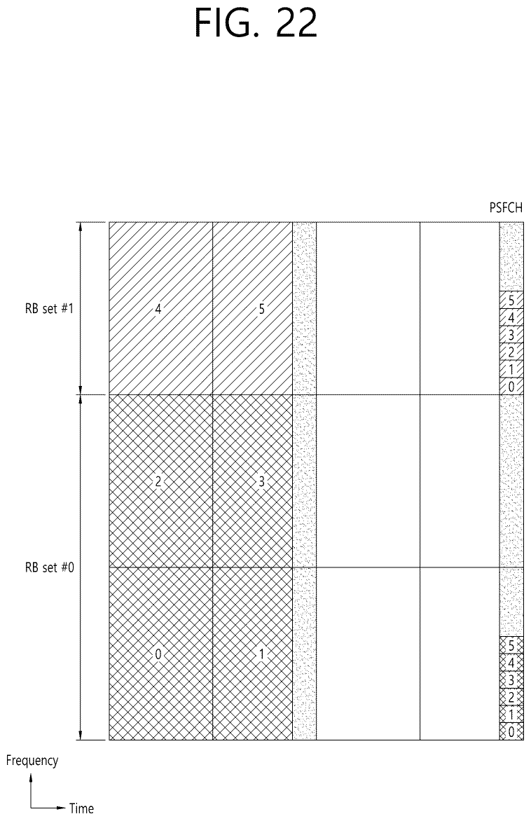

If we consider multiple PSFCH transmission chances to handle PSFCH transmission dropping due to LBT failure, there could be two domains to be considered. To be specific, since the sensing results could be different across different RB sets, it can be considered that the UE attempts to access multiple RB sets to transmit a single PSFCH transmission. In this case, once the UE succeeds to access at least one RB set, then the UE can use the PSFCH resource within the RB set for PSFCH transmission. To avoid sensing operation for PSFCH, the implicit mapping rule can be used. For instance. PRB groups for PSFCH transmission are (pre)configured in each RB set, and Rel-16 PSSCH-to-PSFCH resource determination rule is applied to each RB set. FIG. 22 shows an example of PSSCH-to-PSFCH mapping for each RB set.

FIG. 22 shows an example of PSSCH-to-PSFCH mapping for handling PSFCH TX dropping due to LBT failure. The embodiment of FIG. 22 may be combined with various embodiments of the present disclosure.

In this example, the PSSCH transmission with index n is associated with PSFCH resource with index n.

Another domain is to increase the PSFCH time-domain occasions associated with the same PSSCH slot. To do this, it can be considered that the UE is (pre)configured with more than one sl-MinTimeGapPSFCH and the difference between minimum timing values will be larger than or equal to the value of PSFCH resource period. In this case, for a given PSSCH slot, there could be more than one PSFCH time-domain occasions to be associated with the PSSCH slot. To avoid PSFCH resource collisions between different PSSCH-to-PSFCH timelines, PRB groups for PSFCH transmission are (pre)configured in each timeline, and Rel-16 PSSCH-to-PSFCH resource determination rule is applied to each timeline.

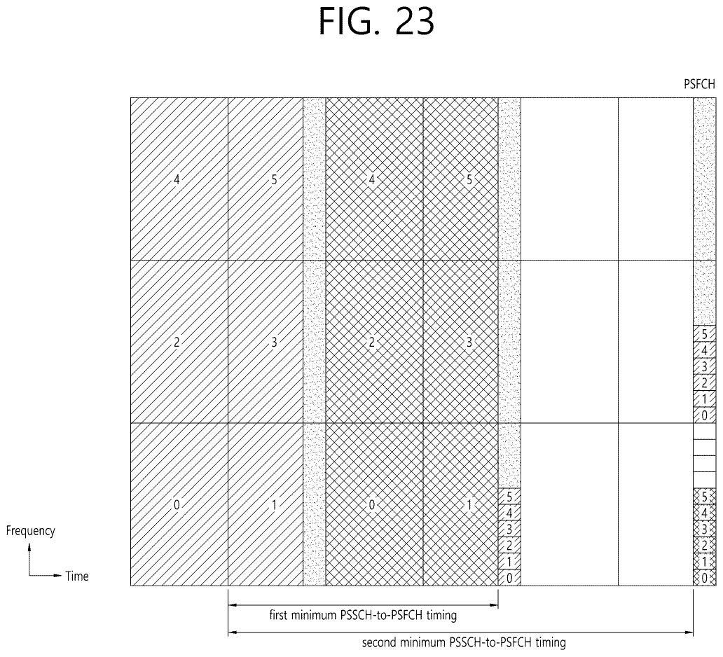

FIG. 23 shows an example of PSSCH-to-PSFCH mapping for handling PSFCH TX dropping due to LBT failure, based on an embodiment of the present disclosure. The embodiment of FIG. 23 may be combined with various embodiments of the present disclosure.

FIG. 23 shows an example of PSSCH-to-PSFCH mapping for each timeline. In this example, the PSSCH transmission with index n is associated with PSFCH resource with index n. This approach may not be suitable for the case when the PDB is limited. Alternatively, instead of multiple PSFCH slots, it can be considered to allow multiple PSFCH occasions in a slot. However, it would require huge specification work for multiplexing PSCCH/PSSCH/PSFCH in a slot.

In the above approaches, the above approaches require additional frequency resources for PSFCH transmissions. Therefore, this approach would be applicable when a single PRB is used for PSFCH transmission. On the other hand, if a number of PRBs are used for PSFCH transmission as in interlaced RB-based PSFCH transmission, it would not be possible to reserve frequency domain resources for PSFCH transmission further for this purpose. In other words, mechanisms for handling PSFCH TX dropping due to LBT failure would not be applicable to all types of PSFCH transmissions.

For example, for more than 1 PSFCH occasion per PSCCH/PSSCH transmission, the following can be discussed:
Option 1: The UE tries to transmit SL HARQ-ACK feedback on the PSFCH resource in the next RB set. The R16 NR SL PSSCH-to-PSFCH resource determination rule is applied to each RB set. The UE can use the PSFCH resource in the RB set which the UE succeeds to access.
Option 2: The UE tries to transmit SL HARQ-ACK feedback on the PSFCH resource in the next PSFCH occasion. For each min-PSSCH-to-PSFCH timing, the UE is (pre)configured with different PRB groups for PSFCH resources. The R16 NR SL PSSCH-to-PSFCH resource determination rule is applied to each PSFCH occasion. Further discussion is needed for the case where PSFCH occasions are present in the same slot or different slots. The UE can use the PSFCH resource in the earliest PSFCH occasion which the UE succeeds to access the channel.

Meanwhile, when we consider more than one PSFCH occasion per PSCCH/PSSCH transmission, it is necessary to investigate when and how to perform PSFCH TX/TX or TX/RX prioritization rule with respect to the PSFCH occasion to be used for actual PSFCH transmission. For instance, if PSFCH TX/TX prioritization is performed first, it would be possible that the PSFCH with high priority fails to access the channel while the PSFCH with low priority can access the channel but it is already dropped. In this case, the UE may not transmit any PSFCH transmission due to LBT failure and PSFCH TX/TX or TX/RX prioritization. Moreover, it would be necessary to clarify whether the UE performs PSFCH RX if the UE drops PSFCH TX with high priority due to LBT failure. Alternatively, if PSFCH TX/TX prioritization is performed after channel sensing operation for each PSFCH or each RB set, the processing time for preparing PSFCH transmissions may not be sufficient. To be specific, after channel sensing, the UE may have a few msec, and the UE may need to regenerate OFDM waveform based on the selected PSFCH transmissions during the few msec.

Another issue is that when a UE fails to transmit PSFCH on the 1^{st} PSFCH occasion due to LBT failure, it is also possible that the PSFCH on the 2^{nd} PSFCH occasion is dropped again due to PSFCH TX/TX or TX/RX prioritization. In this case, it would be better to use additional PSFCH occasion(s) even for the PSFCH dropping due to prioritization rules. Or, it can be considered to prioritize the dropped PSFCH when the UE tries to transmit the PSFCH in the next PSFCH occasion.

For more than 1 PSFCH occasion per PSCCH/PSSCH transmission. RANI discusses when and how to perform PSFCH TX/TX or TX/RX prioritization. For example, it is discussed whether PSFCH TX/TX or TX/RX prioritization is performed before or after channel sensing operation. For example, it is discussed whether a UE can transmit PSFCH on additional PSFCH occasion if PSFCH on a PSFCH occasion is dropped due to PSFCH TX/TX or TX/RX prioritization.

In case of PSFCH transmission, considering multiplexing capacity, the interlaced transmission could be considered rather than wideband transmission. Since the PSFCH format 0 is designed based on PUCCH format 0 and the PUCCH format 0 has interlaced transmission form, it can be considered that interlaced transmission form of PUCCH format 0 is considered as a baseline for interlaced PSFCH transmission. Since the number of PRBs for a single PSFCH transmission would be highly increased, it would be necessary to check whether the number of PSFCH resources are sufficient. To increase the number of PSFCH resources, it can be considered to apply time-domain and/or frequency-domain OCC to PSFCH transmission. In case of time-domain OCC, it would be necessary to carefully investigate the impact of power imbalance across different symbols due to OCC. To be specific, when PSFCH transmission(s) with OCC [+1 +1] will be CDMed with PSFCH transmission(s) with OCC [+1 −1], the total received power at the RX UE side will be changed across different OFDM symbols. For instance, if the channel phase is the same for all the PSFCH transmission(s) with different OCC, the received signals will be positively combined on the first OFDM symbol while the received signals will be canceled out on the second OFDM symbol. The power imbalance in time domain would have negative impact on the AGC performance. Moreover, since the first symbol will be used for AGC, time-domain OCC would not be always feasible for all the UEs. In case of frequency-domain OCC. PAPR needs to be checked. Alternatively, it can be considered to introduce a comb structure for the interlaced PSFCH transmission. However, in this case, the number of cyclic shift pairs could be reduced, so total number of PSFCH resources would not be large enough. Another approach is to additionally use common interlace. However, in this case, most TX power will not be used to convey HARQ-ACK information. In other words, due to PSD restriction. SL HARQ-ACK detection performance will be highly degraded.

When the PSFCH resource is associated with RB set index and interlaced index, it would be necessary to modify the implicit PSSCH-to-PSFCH resource determination rule as well. According to Rel-16 NR SL, subchannel index and slot index of PSSCH are used to determine RB sub-group of PSFCH, and source ID of PSSCH is used to determine RB index within the RB sub-group and cyclic shift pair index. For interlaced PSFCH transmission, it would be necessary to define how RB set index and interlace index of PSFCH are derived from PSSCH resource and source ID. Due to limited number of frequency resources of the interlaced RB-based PSFCH transmission, subgrouping would need to be extended to code-domain resources. For instance, the UE can determine the subset of interlaces and RB sets and cyclic shift pairs based on subchannel. RB set, and slot associated with PSSCH transmission. Then, the UE finally selects PSFCH resource within the subset of PSFCH resource candidates based on source ID and/or M_ID.

For example, for interlaced RB-based PSFCH transmission with 15 kHz SCS or 30 KHz SCS, the interlaced PUCCH format 0) is considered as a baseline. For the PSSCH-to-PSFCH determination rule, among a (pre)configured set of interlaces. RB sets, and cyclic shift pairs for PSFCH transmission. PSFCH resource indexing is done in increasing order of first interlace index, and then RB set index, and then cyclic shift pair index, and/or the set of PSFCH resources is partitioned by the RB set of PSSCH, and then is partitioned by the interlace of PSSCH, and then is partitioned by PSSCH slot, and/or within the subset of PSFCH resources, the UE selects the final PSFCH resource index based on source ID and/or M_ID.

In this approach, unlike Rel-16 NR SL, it will allow CDM among PSFCH resources associated with PSSCH transmission of which resources are TDMed and/or FDMed.

Meanwhile, for 60 KHz SCS, since there is no definition for an RB-based interlace structure in NR-U, it is necessary to discuss how to meet the OCB and PSD requirements for PSFCH transmission with 60 kHz SCS. Rather than specifying a new RB-based interlaced structure for 60 kHz SCS, it can be considered to support 2-RB PSFCH transmission to meet the OCB and PSD requirements.

For example, for PSFCH transmission with 60 KHz SCS, to meet the OCB and PSD requirements. R16 PSFCH is mapped on 2 PRBs equally distributed over an RB set. The PRB gap is implicitly or explicitly determined, and/or a (pre) configuration provides the RB set(s) and/or the PRB gap for PSFCH mapping.

In RANI #110 meeting, the possibility was discussed of introducing common PRBs or common interlaces to meet the OCB requirement for PSFCH transmission. However, since the common PRBs are not used to convey actual information, the coverage of PSFCH will be highly restricted. Due to the PSD requirement, the PSFCH coverage will be further restricted. Considering that the PSCCH/PSSCH will use an RB-based interlaced structure, even though the PSFCH format 0 is sequence-based transmission, its coverage would be largely different, and the reduced coverage will limit the applicable scenario of SL-U as well. Moreover, since a number of UEs can transmit signals on the common PRBs in SFN manner, it will make an IBE issue worsened.

For PSFCH transmission to meet the OCB requirement, the usage of common PRBs or common interlaces has a limited PSFCH coverage issue, and an IBE issue.

### 4. Synchronization Procedure and Channels

Depending on the regulation. S-SSB transmission also needs to meet the OCB requirement and the PSD requirement. For this purpose, a number of options are listed in RANI #109-e meeting.

On the time domain resources for S-SSB, unlike NR-U. S-SSB transmission is performed by a UE whose TX power would be limited. In Rel-16 NR SL, a 2-symbol duration of S-PSS and S-SSS could achieve energy combining gain. From that point of view; at least for S-PSS and S-SSS need to have a 2-symbol duration as in Rel-16 NR SL. Moreover, considering that the first symbol of S-SSB is used for AGC, even if a 1-symbol duration is used for both S-PSS and S-SSS, only one symbol will be effectively used to decode PSBCH for a 4-symbol duration of S-SSB transmission. It will restrict SL communication coverage and make SL transmissions asynchronous.

Considering the coverage of SL communication the S-SSB structure in the time domain (i.e., 2-symbol S-PSS and 2-symbol S-SSS) needs to be kept to achieve energy combining gain.

For example, for S-SSB in SL-U, the R16 S-SSB structure in the time domain is reused (i.e., a 14-symbol duration of S-SSB for normal CP, and a 12-symbol duration of S-SSB for extended CP).

In our view; the typical scenario of S-SSB transmission is to use the Type 2A channel access procedure rather than the Type 1 channel access procedure with the help of MCSt exemption. In this case, the additional candidate S-SSB occasions could be simply achieved by modifying the description of the higher layer parameter sl-NumSSB-WithinPeriod to allow more S-SSB occasions for each SCS or by adding more candidate values for the higher layer parameter sl-NumSSB-WithinPeriod. In this approach, the specification impact or workload could be minimized. Otherwise, to design new S-SSB occasions, it would be necessary to further discuss how to modify sl-SSB-TimeAllocation1, sl-SSB-TimeAllocation2, sl-SSB-TimeAllocation3, and UE behavior for the usage of additional S-SSB occasions.

For example, for additional candidate S-SSB occasions, the higher layer parameter sl-NumSSB-WithinPeriod is modified to allow more candidate values for each SCS.

In RANI #110bis-e meeting, it was discussed how a UE uses additional S-SSB occasions for S-SSB transmission. Unlike NR-U discovery burst, S-SSB is transmitted by a number of UEs in SFN manner. It is motivated by the fact that the synchronization is important even for UEs who are not actually communicating with each other to identify and avoid reserved resources of other UEs. Moreover, the periodicity of DL discovery burst could be shorter than 160 msec, but the periodicity of S-SSB is fixed to 160 msec. From those points of views, it is necessary to maximize the case when a number of UEs transmit S-SSB on the same occasion in SFN manner. If the usage of additional S-SSB occasions can be different depending on the channel sensing results or other factors, it will cause the case where a small number of UEs will transmit S-SSB on the same S-SSB occasion, and it will reduce the coverage of S-SSB as well. Extremely, it would be possible that no one transmits S-SSB on a certain S-SSB occasion while RX UEs still expect to receive S-SSB. It could cause false alarm issue as well.

For example, regarding additional candidate S-SSB occasions, in the same S-SSB period, the UE always attempts to transmit on all the additional candidate S-SSB occasion(s) regardless of whether or not it has transmitted on R16/R17 S-SSB occasion(s).

According to EN 301 893, within a COT duration, the UE may not need to fulfil the OCB requirement temporarily as follows:
During a channel occupancy time (COT), equipment may operate temporarily with an occupied bandwidth of less than 80% of its nominal channel bandwidth. The occupied bandwidth shall not be less than 2 MHZ.

Since S-PSS and S-SSS start from the second symbol of S-SSB, it is understood that both S-PSS and S-SSS would be within the COT duration. In this case, it would be possible to reuse the existing S-PSS and S-SSS sequences without consideration of the OCB requirement. However, in this case, due to the PSD requirement, the total power of the S-PSS and S-SSS would be too small, and would restrict the coverage of S-SSB.

According to EN 301 893, the temporary exemption from the OCB requirement can be applicable at least for S-PSS and S-SSS. However, due to the PSD requirement, the coverage of S-SSB would be too restrictive.

Moreover, if the transmission BW is quite different across different symbols, it requires a transient period between these symbols. Signal distortion due to the transient period will degrade the detection performance of S-SSB. If the transient period is set on the S-PSS symbol, the UE may use only one S-PSS symbol for S-PSS detection. If the transient period is set on the 1^{st} OFDM symbol of S-SSB, it is necessary to carefully check the impact on the AGC performance. To mitigate the transient period issue, it would be necessary to change the S-SSB structure. For instance, the number of S-PSS symbols can be increased to 3 symbols. Alternatively, if the SL-U targets only on the short-distance scenario, it can be considered to introduce comb-type S-PSS/S-SSS. In this case, since the S-PSS will be repeated twice in time domain, the transient period would be accommodated. Moreover, comb-type mapping will ensure the 2 MHZ requirement.

If the temporary exemption from the OCB requirement is applied to S-PSS and S-SSS, it is necessary to handle the additional transient period issue.

For example, the temporary exemption from the OCB requirement for a part of S-SSB is not supported in Rel-18 SL.

In the case of interlaced RB-based S-SSB transmission, it would be possible to reuse the existing sequences if the number of PRBs belonging to one interlace within an RB set is 11. Otherwise, it would be necessary to use two interlaces for S-SSB transmission. If two interlaces within an RB set are used for S-SSB transmission, due to the PSD requirement, the TX power would be limited compared to the case when one interlace is used.

For interlaced RB-based transmission for S-SSB, depending on the number of PRBs associated with a single interlace, it would be necessary to use two interlaces for S-SSB transmission to ensure bandwidth of 11 PRBs.

For interlaced RB-based transmission for S-SSB, if two interlaces are used, the PSD would be halved compared to the case when a single interlace is used due to the PSD requirement.

In NR-U, the interlaced structure is defined for 15 kHz SCS and 30 kHz SCS, but not for 60 KHz SCS. Meanwhile, in Rel-16 NR SL, for FR1. S-SSB transmission is supported for 60 kHz. For 60 kHz SCS, it would be necessary to define interlaced structure or to adopt another approach for the OCB requirement. The PRB gap between interlaces is 10 or 5 for 15 kHz or 30 kHz, respectively. Since 5/2 is not an integer, it seems not straightforward to design interlace structure for 60 KHz.

For 60 KHz SCS, since the interlace structure is not defined in NR-U, interlaced RB-based S-SSB transmission would not be straightforward.

Moreover, in NR-U, since the interlaced RB-based transmission is a part of the UE capability, it would be possible that UEs without the capability cannot relay the received S-SSB transmission. In this case, the system performance of the synchronization procedure and the subsequent Mode 2 operation would be degraded further due to the synchronization error.

For interlaced RB-based S-SSB transmission. UEs without interlaced RB-based transmission cannot relay the received S-SSB transmission, and it will cause system performance degradation due to synchronization error.

For the OCB and PSD requirements, repetition of S-SSB in frequency domain was also discussed in RANI #109-e meeting. However, in this case. PAPR could be highly increased. To alleviate this high PAPR problem, at least S-PSS and S-SSS could be repeated with phase adjustment while a PSBCH is transmitted in wideband transmission manner. Moreover, since S-PSS and S-SSS have guard band within 11 PRB, the repetition in frequency domain can be seen as simultaneous SL transmissions, so PAPR/CR analysis needs to be investigated first.

Repetition of S-SSB in frequency domain would increase PAPR, and it will further reduce coverage.

Considering that the S-SSB transmission will not be FDMed with other SL channel(s), it seems that the RB-based interlace structure for S-SSB transmission does not need to be the same as that of PSCCH/PSSCH, or PSFCH transmission. For unified design across different SCS, it can be considered that R16 S-PSS/S-SSS/PSBCH are mapped on 11 PRBs which are equally distributed over an RB set.

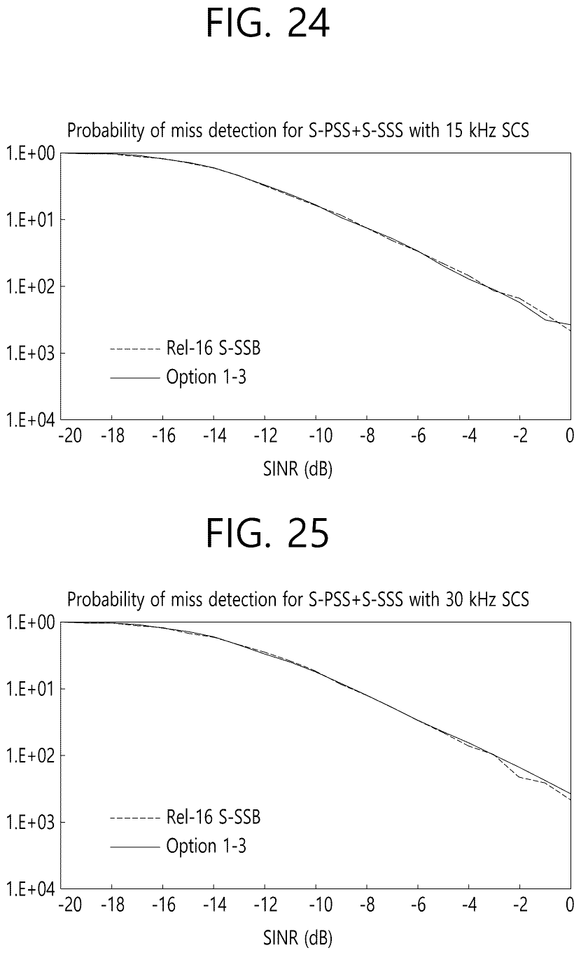

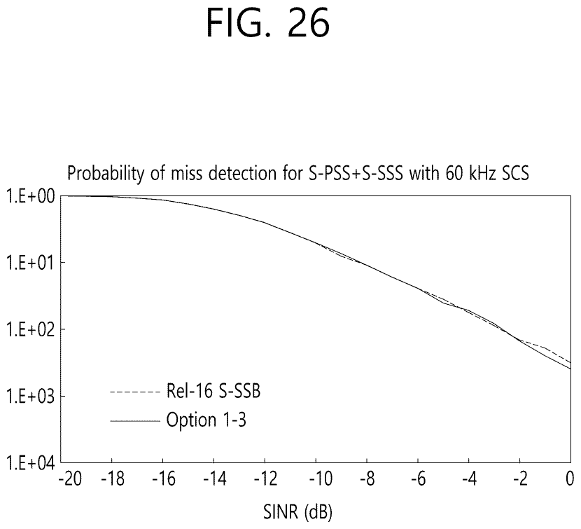

FIGS. 24 to 26 show the detection performance of S-PSS and S-SSS, based on an embodiment of the present disclosure. Specifically. FIG. 24 shows the detection performance of S-PSS and S-SSS for 15 kHz SCS, based on an embodiment of the present disclosure, and FIG. 25 shows the detection performance of S-PSS and S-SSS for 30 KHz SCS, based on an embodiment of the present disclosure, and FIG. 26 shows the detection performance of S-PSS and S-SSS for 60 kHz SCS, based on an embodiment of the present disclosure.

The misdetection probabilities of S-PSS and S-SSS between the R16 mapping rule and the proposed mapping rule are compared as shown in FIGS. 24 to 26. According to FIGS. 24 to 26, for all the SCS, the proposed scheme achieves comparable detection performance compared to the R16 S-SSB. Moreover, we observed that the PAPR/CM of the proposed scheme does not affect the S-SSB detection performance and the S-SSB coverage.

For example, for S-SSB in SL-U, support Option 1 to meet the OCB and PSD requirements for S-SSB transmission:

For example, in the case of option 1, interlaced RB transmission is used. For details, down-select one of the following:

For example, in the case of option 1-1. R16 S-PSS/S-SSS/PSBCH are mapped on 11 PRBs associated with one or two interlaces within an RB set, and/or a (pre) configuration provides the RB set(s) and interlace(s) for S-SSB mapping.

For example, in the case of option 1-2. R16 S-PSS/S-SSS/PSBCH are mapped on PRBs associated with one interlace within an RB set, and/or if the number of PRBs associated with the interlace within the RB set is smaller than 11 PRBs, parts of sequences can be truncated, and/or a (pre) configuration provides the RB set(s) and interlace(s) for S-SSB mapping.

For example, in the case of option 1-3. R16 S-PSS/S-SSS/PSBCH are mapped on 11 PRBs equally distributed over an RB set, and/or PRB gap is implicitly or explicitly determined, and/or a (pre) configuration provides the RB set(s) and/or PRB gap for S-SSB mapping.

For example, whether or not the above rule is applied (and/or the parameter value related to the proposed method of the present disclosure) may be configured/allowed specifically (or differently or independently) (and/or the application of the above rule may be configured/allowed limitedly) based on at least one of the following elements/parameters (or for each of the following elements/parameters) comprising: a service type (and/or a (LCH or service) priority) and/or a QoS requirement (e.g., latency: reliability, minimum communication range) and/or a PQI parameter) (and/or HARQ FEEDBACK ENABLED (and/or DISABLED) LCH/MAC PDU (transmission) and/or a CBR measurement value of a resource pool and/or a SL cast type (e.g., unicast, groupcast, broadcast) and/or a SL groupcast HARQ feedback option (e.g., NACK ONLY feedback. ACK/NACK feedback. TX-RX distance-based NACK ONLY feedback) and/or a SL mode 1 CG type (e.g., SL CG type 1/2) and/or a SL mode type (e.g., mode 1/2) and/or a resource pool and/or whether a PSFCH resource is configured for a resource pool and/or whether periodic resource reservation operation (and/or aperiodic resource reservation operation) is allowed/configured (or not allowed/configured) for a resource pool and/or whether partial sensing operation (and/or random resource selection operation (and/or full sensing operation)) is allowed/configured (or not allowed/configured) for a resource pool and/or a source (L2) ID (and/or a destination (L2) ID) and/or a PC5 RRC connection link and/or a SL link and/or a connection state (with a base station) (e.g., RRC CONNECTED state. RRC IDLE state. RRC INACTIVE state) and/or a SL HARQ process (ID) and/or whether SL DRX operation (of a TX UE or an RX UE) is performed and/or whether it is a power saving (TX or RX) UE and/or a case where (from the perspective of a particular UE) PSFCH TX and PSFCH RX (and/or multiple PSFCH TXs (exceeding a UE capability)) overlap (and/or PSFCH TX (and/or PSFCH RX) is skipped) and/or a case where an RX UE actually (successfully) receives a PSCCH (and/or PSSCH) (re) transmission from a TX UE and/or a case where a (TX) UE performing packet transmission (and/or transmission resource (re)selection) performs power saving operation (and/or SL DRX operation) and/or a case where a target (RX) UE of packet transmission performs power saving operation (and/or SL DRX operation) and/or a case where the remaining PDB value related to packet transmission is greater than or equal to (or less than or equal to) a pre-configured threshold and/or a case of (TB-related) initial transmission (and/or retransmission) and/or a case where an interlace-based (RB) structure is applied and/or a case where a (pre-configured) channel access type (e.g., Type 1, Type 2A, Type 2B, Type 2C, semi-static channel occupancy) is performed and/or a case where transmission/reception of a (pre-configured) SL channel/signal (e.g., SL SSB, PSCCH, PSSCH, PSFCH) is performed and/or an RB set (and/or channel and/or carrier) (on which channel access operation is performed in an unlicensed band) and/or a channel occupancy time (COT) and/or a TX burst and/or a discovery burst). In addition, combinations of the proposed methods (and/or proposed rules and/or embodiments) described in the present disclosure may be applied. Further, in the present disclosure, the term “configuration/being configured” (or “designation/being designated”) may be extended to or interpreted as a form that the base station informs the UE through a pre-defined (physical layer or upper layer) channel/signal (e.g., SIB, RRC, MAC CE) (and/or a form provided through pre-configuration and/or a form that the UE informs another UE through a pre-defined (physical layer or upper layer) channel/signal (e.g., SL MAC CE, PC5 RRC)). In addition, the term “PSFCH” in the present disclosure may be extended to or interpreted as “(NR or LTE) PSSCH (and/or (NR or LTE) PSCCH) (and/or (NR or LTE) SL SSB (and/or UL channel/signal))” (or vice versa). In addition, the proposed methods of the present disclosure may be combined with each other and extended (in new forms). In addition, in the present disclosure, the term “ACTIVE TIME” (and/or “ON DURATION”) may be extended to or interpreted as “ON DURATION” (and/or “ACTIVE TIME”) (or vice versa).

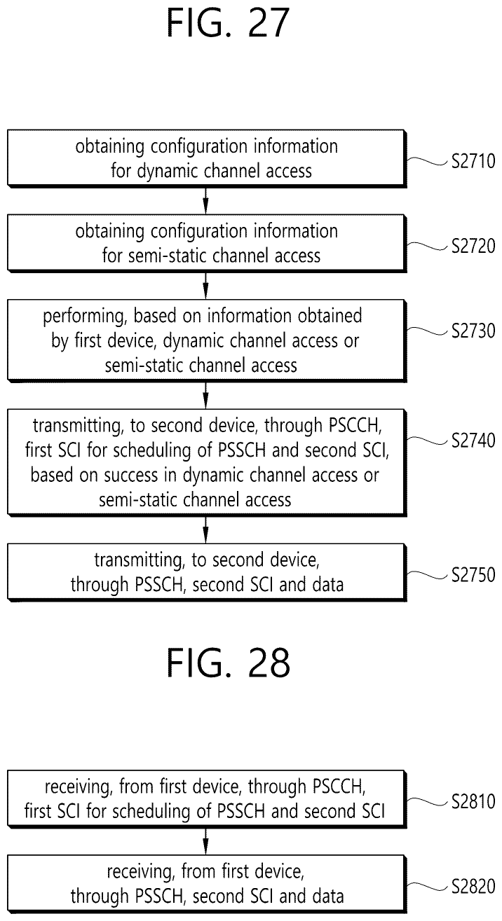

FIG. 27 shows a method for a first device to perform wireless communication, based on an embodiment of the present disclosure. The embodiment of FIG. 27 may be combined with various embodiments of the present disclosure.

Referring to FIG. 27, in step S2710, the first device may obtain configuration information for dynamic channel access. In step S2720, the first device may obtain configuration information for semi-static channel access. In step S2730, the first device may perform, based on information obtained by the first device, the dynamic channel access or the semi-static channel access. In step S2740, the first device may transmit, to a second device, through a physical sidelink control channel (PSCCH), first sidelink control information (SCI) for scheduling of a physical sidelink shared channel (PSSCH) and second SCI, based on success in the dynamic channel access or the semi-static channel access. In step S2750, the first device may transmit, to the second device, through the PSSCH, the second SCI and data.

For example, the information obtained by the first device may be information related to a location of the first device. For example, based on that the location of the first device is within an area configured for the first device, the semi-static channel access may be performed by the first device. For example, based on that the location of the first device is outside an area configured for the first device, the dynamic channel access may be performed by the first device. For example, based on that the information related to the location of the first device is unavailable, the dynamic channel access may be performed by the first device. For example, based on that reliability of the information related to the location of the first device is less than or equal to a threshold, the dynamic channel access may be performed by the first device.

For example, the information obtained by the first device may be information related to a congestion level. For example, the dynamic channel access or the semi-static channel access may be selected by the first device based on the congestion level.

For example, the information obtained by the first device may be information related to whether a channel or a signal related to a different radio access technology (RAT) from that of the first device is detected. For example, based on detection of the channel or the signal related to the different RAT than that of the first device, the dynamic channel access may be performed by the first device. For example, based on no detection of the channel or the signal related to the different RAT than that of the first device, the semi-static channel access may be performed by the first device.

For example, the information obtained by the first device may be information indicated by a sidelink-synchronization signal block (S-SSB).

For example, the information obtained by the first device may be information obtained from at least one of a base station, a road side unit (RSU), another device, or a pre-configuration.

The proposed method can be applied to devices based on various embodiments of the present disclosure. First, the processor 102 of the first device 100 may obtain configuration information for dynamic channel access. In addition, the processor 102 of the first device 100 may obtain configuration information for semi-static channel access. In addition, the processor 102 of the first device 100 may perform, based on information obtained by the first device, the dynamic channel access or the semi-static channel access. In addition, the processor 102 of the first device 100 may control the transceiver 106 to transmit, to a second device, through a physical sidelink control channel (PSCCH), first sidelink control information (SCI) for scheduling of a physical sidelink shared channel (PSSCH) and second SCI, based on success in the dynamic channel access or the semi-static channel access. In addition, the processor 102 of the first device 100 may control the transceiver 106 to transmit, to the second device, through the PSSCH, the second SCI and data.

Based on an embodiment of the present disclosure, a first device adapted to perform wireless communication may be provided. For example, the first device may comprise: at least one transceiver: at least one processor; and at least one memory connected to the at least one processor and storing instructions. For example, the instructions, based on being executed by the at least one processor, may cause the first device to perform operations comprising: obtaining configuration information for dynamic channel access: obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

Based on an embodiment of the present disclosure, a processing device adapted to control a first device may be provided. For example, the processing device may comprise: at least one processor; and at least one memory connected to the at least one processor and storing instructions. For example, the instructions, based on being executed by the at least one processor, may cause the first device to perform operations comprising: obtaining configuration information for dynamic channel access: obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

Based on an embodiment of the present disclosure, a non-transitory computer-readable storage medium storing instructions may be provided. For example, the instructions, when executed, may cause a first device to perform operations comprising: obtaining configuration information for dynamic channel access: obtaining configuration information for semi-static channel access: performing, based on information obtained by the first device, the dynamic channel access or the semi-static channel access: transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and transmitting, to the second device, through the PSSCH, the second SCI and data.

FIG. 28 shows a method for a second device to perform wireless communication, based on an embodiment of the present disclosure. The embodiment of FIG. 28 may be combined with various embodiments of the present disclosure.

Referring to FIG. 28, in step S1410, the second device may receive, from a first device, through a physical sidelink control channel (PSCCH), first sidelink control information (SCI) for scheduling of a physical sidelink shared channel (PSSCH) and second SCI. In step S1420, the second device may receive, from the first device, through the PSSCH, the second SCI and data. For example, transmission by the first device may be performed based on dynamic channel access or semi-static channel access. For example, based on information obtained by the first device, the dynamic channel access or the semi-static channel access may be performed by the first device.

The proposed method can be applied to devices based on various embodiments of the present disclosure. First, the processor 202 of the second device 200 may control the transceiver 206 to receive, from a first device, through a physical sidelink control channel (PSCCH), first sidelink control information (SCI) for scheduling of a physical sidelink shared channel (PSSCH) and second SCI. In addition, the processor 202 of the second device 200 may control the transceiver 206 to receive, from the first device, through the PSSCH, the second SCI and data. For example, transmission by the first device may be performed based on dynamic channel access or semi-static channel access. For example, based on information obtained by the first device, the dynamic channel access or the semi-static channel access may be performed by the first device.

Based on an embodiment of the present disclosure, a second device adapted to perform wireless communication may be provided. For example, the second device may comprise: at least one transceiver: at least one processor; and at least one memory connected to the at least one processor and storing instructions. For example, the instructions, based on being executed by the at least one processor, may cause the second device to perform operations comprising: receiving, from a first device, through a physical sidelink control channel (PSCCH), first sidelink control information (SCI) for scheduling of a physical sidelink shared channel (PSSCH) and second SCI; and receiving, from the first device, through the PSSCH, the second SCI and data. For example, transmission by the first device may be performed based on dynamic channel access or semi-static channel access. For example, based on information obtained by the first device, the dynamic channel access or the semi-static channel access may be performed by the first device.

Based on an embodiment of the present disclosure, a processing device adapted to control a second device may be provided. For example, the processing device may comprise: at least one processor; and at least one memory connected to the at least one processor and storing instructions. For example, the instructions, based on being executed by the at least one processor, may cause the second device to perform operations comprising: receiving, from a first device, through a physical sidelink control channel (PSCCH), first sidelink control information (SCI) for scheduling of a physical sidelink shared channel (PSSCH) and second SCI; and receiving, from the first device, through the PSSCH, the second SCI and data. For example, transmission by the first device may be performed based on dynamic channel access or semi-static channel access. For example, based on information obtained by the first device, the dynamic channel access or the semi-static channel access may be performed by the first device.

Based on an embodiment of the present disclosure, a non-transitory computer-readable storage medium storing instructions may be provided. For example, the instructions, when executed, may cause a second device to perform operations comprising: receiving, from a first device, through a physical sidelink control channel (PSCCH), first sidelink control information (SCI) for scheduling of a physical sidelink shared channel (PSSCH) and second SCI; and receiving, from the first device, through the PSSCH, the second SCI and data. For example, transmission by the first device may be performed based on dynamic channel access or semi-static channel access. For example, based on information obtained by the first device, the dynamic channel access or the semi-static channel access may be performed by the first device.

Based on various embodiments of the present disclosure, the UE can determine whether to perform a dynamic channel access procedure or a semi-static channel access procedure based on whether pre-configured condition(s) (e.g., UE location, congestion level, whether a specific RAT (e.g., WI-FI) is detected, etc.) is satisfied. For example, if the UE location is included in a pre-configured area, the UE can apply the semi-static channel access procedure. However, if the UE location information is not available and/or the reliability of the UE location measurement value is less than or equal to a pre-configured threshold level, the UE can apply the dynamic channel access procedure. Through this, the changing/switching between the dynamic channel access procedure and the semi-static channel access procedure can be appropriately performed, and the probability of transmission resource collision with other entities (e.g., WI-FI, SL-U UE) can be minimized.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

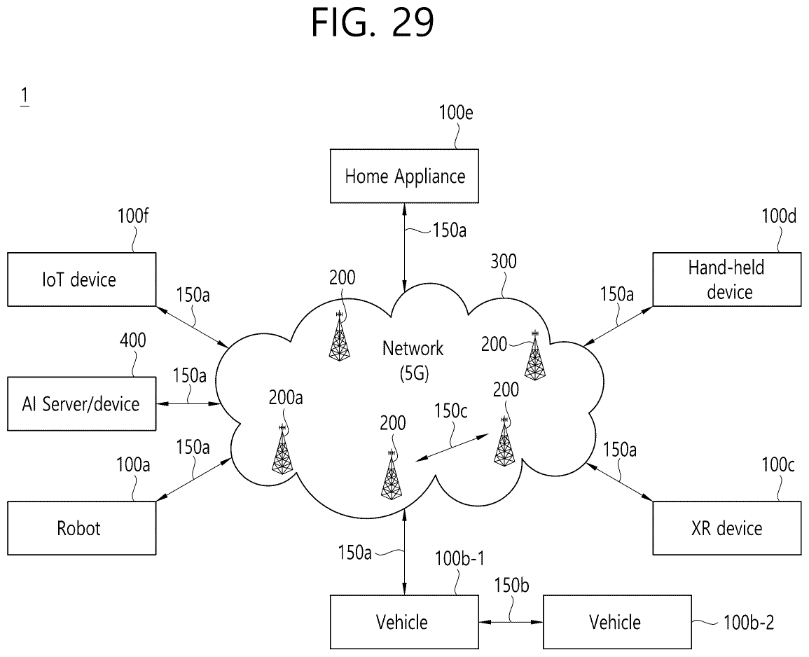

FIG. 29 shows a communication system 1, based on an embodiment of the present disclosure. The embodiment of FIG. 29 may be combined with various embodiments of the present disclosure.

Referring to FIG. 29, a communication system 1 to which various embodiments of the present disclosure are applied includes wireless devices. Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IOT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example. NB-IOT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a. 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

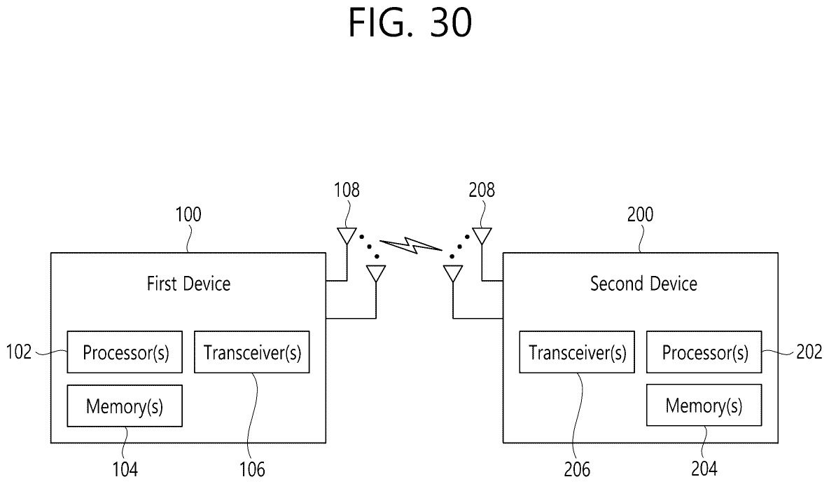

FIG. 30 shows wireless devices, based on an embodiment of the present disclosure. The embodiment of FIG. 30 may be combined with various embodiments of the present disclosure.

Referring to FIG. 30, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 29.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs. SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs. SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs). Random Access Memories (RAMs). Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

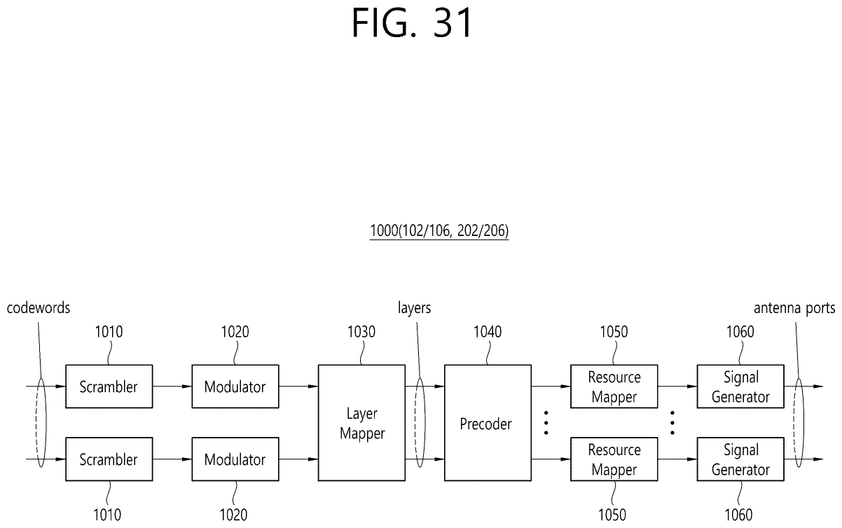

FIG. 31 shows a signal process circuit for a transmission signal, based on an embodiment of the present disclosure. The embodiment of FIG. 31 may be combined with various embodiments of the present disclosure.

Referring to FIG. 31, a signal processing circuit 1000 may include scramblers 1010, modulators 1020, a layer mapper 1030, a precoder 1040, resource mappers 1050, and signal generators 1060. An operation/function of FIG. 31 may be performed, without being limited to, the processors 102 and 202 and/or the transceivers 106 and 206 of FIG. 30. Hardware elements of FIG. 31 may be implemented by the processors 102 and 202 and/or the transceivers 106 and 206 of FIG. 30. For example, blocks 1010 to 1060 may be implemented by the processors 102 and 202 of FIG. 30. Alternatively, the blocks 1010 to 1050 may be implemented by the processors 102 and 202 of FIG. 30 and the block 1060 may be implemented by the transceivers 106 and 206 of FIG. 30.

Codewords may be converted into radio signals via the signal processing circuit 1000 of FIG. 31. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein. N is the number of antenna ports and M is the number of transport layers. The precoder 1040 may perform precoding after performing transform precoding (e.g., DFT) for complex modulation symbols. Alternatively: the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules. Cyclic Prefix (CP) inserters. Digital-to-Analog Converters (DACs), and frequency up-converters.

Signal processing procedures for a signal received in the wireless device may be configured in a reverse manner of the signal processing procedures 1010 to 1060 of FIG. 31. For example, the wireless devices (e.g., 100 and 200 of FIG. 30) may receive radio signals from the exterior through the antenna ports/transceivers. The received radio signals may be converted into baseband signals through signal restorers. To this end, the signal restorers may include frequency downlink converters. Analog-to-Digital Converters (ADCs). CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

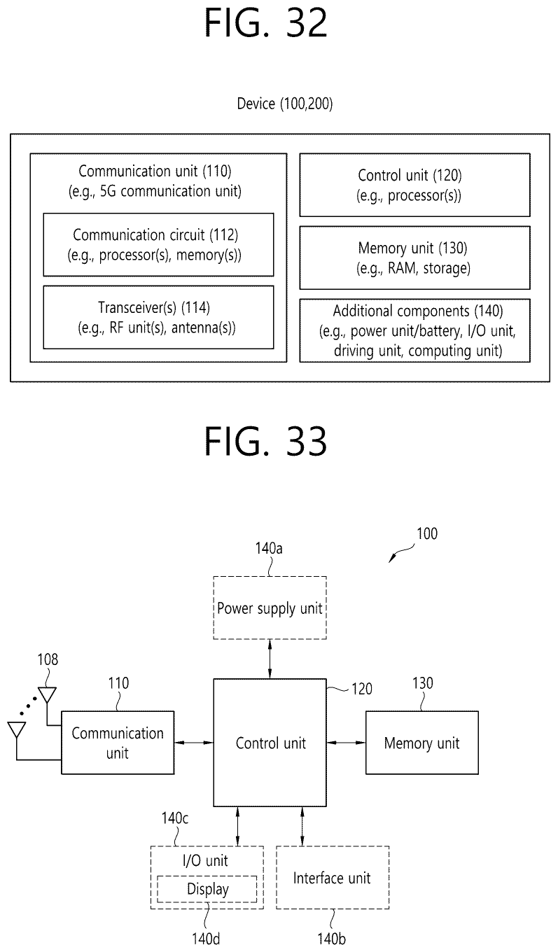

FIG. 32 shows another example of a wireless device, based on an embodiment of the present disclosure. The wireless device may be implemented in various forms according to a use-case/service (refer to FIG. 29). The embodiment of FIG. 32 may be combined with various embodiments of the present disclosure.

Referring to FIG. 32, wireless devices 100 and 200 may correspond to the wireless devices 100 and 200 of FIG. 30 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 30. For example, the transceiver(s) 114 may include the one or more transceivers 106 and 206 and/or the one or more antennas 108 and 208 of FIG. 30. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 29), the vehicles (100b-1 and 100b-2 of FIG. 29), the XR device (100c of FIG. 29), the hand-held device (100d of FIG. 29), the home appliance (100e of FIG. 29), the IoT device (100f of FIG. 29), a digital broadcast terminal, a hologram device, a public safety device, an MTC device, a medicine device, a fintech device (or a finance device), a security device, a climate/environment device, the AI server/device (400 of FIG. 29), the BSs (200 of FIG. 29), a network node, etc. The wireless device may be used in a mobile or fixed place according to a use-example/service.

In FIG. 32, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 32 will be described in detail with reference to the drawings.

FIG. 33 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 33 may be combined with various embodiments of the present disclosure.

Referring to FIG. 33, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 32, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

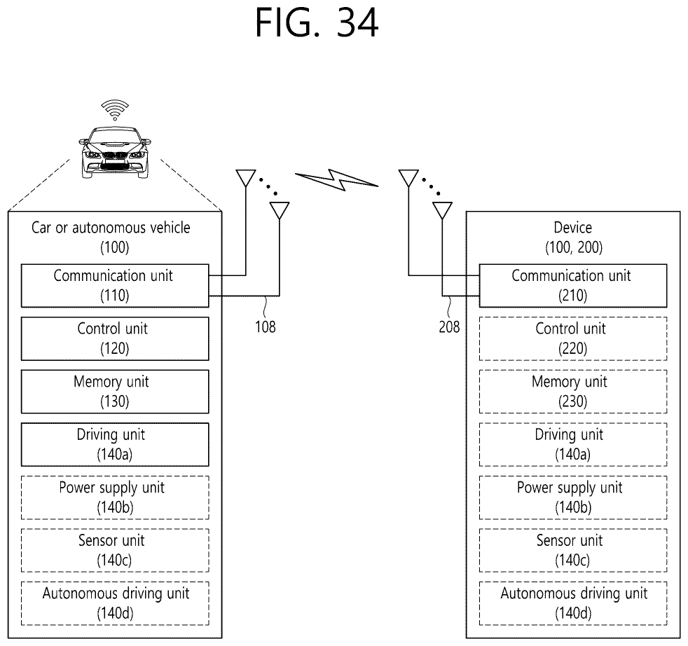

FIG. 34 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 34 may be combined with various embodiments of the present disclosure.

Referring to FIG. 34, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 32, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method comprising:
obtaining, by a first device, configuration information for dynamic channel access;
obtaining, by the first device, configuration information for semi-static channel access;
performing, based on information obtained by the first device, the dynamic channel access or the semi-static channel access;
transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and
transmitting, to the second device, through the PSSCH, the second SCI and data.

2. The method of claim 1, wherein the information obtained by the first device is information related to a location of the first device.

3. The method of claim 2, wherein, based on that the location of the first device is within an area configured for the first device, the semi-static channel access is performed by the first device.

4. The method of claim 2, wherein, based on that the location of the first device is outside an area configured for the first device, the dynamic channel access is performed by the first device.

5. The method of claim 2, wherein, based on that the information related to the location of the first device is unavailable, the dynamic channel access is performed by the first device.

6. The method of claim 2, wherein, based on that reliability of the information related to the location of the first device is less than or equal to a threshold, the dynamic channel access is performed by the first device.

7. The method of claim 1, wherein the information obtained by the first device is information related to a congestion level.

8. The method of claim 7, wherein the dynamic channel access or the semi-static channel access is selected by the first device based on the congestion level.

9. The method of claim 1, wherein the information obtained by the first device is information related to whether a channel or a signal related to a different radio access technology (RAT) from that of the first device is detected.

10. The method of claim 9, wherein, based on detection of the channel or the signal related to the different RAT than that of the first device, the dynamic channel access is performed by the first device.

11. The method of claim 9, wherein, based on no detection of the channel or the signal related to the different RAT than that of the first device, the semi-static channel access is performed by the first device.

12. The method of claim 1, wherein the information obtained by the first device is information indicated by a sidelink-synchronization signal block (S-SSB).

13. The method of claim 1, wherein the information obtained by the first device is information obtained from at least one of a base station, a road side unit (RSU), another device, or a pre-configuration.

14. A first device comprising:
at least one transceiver;
at least one processor; and
at least one memory connected to the at least one processor and storing instructions that, based on being executed by the at least one processor, cause the first device to perform operations comprising:
obtaining configuration information for dynamic channel access;
obtaining configuration information for semi-static channel access;
performing, based on information obtained by the first device, the dynamic channel access or the semi-static channel access;
transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and
transmitting, to the second device, through the PSSCH, the second SCI and data.

15. A processing device adapted to control a first device, the processing device comprising:
at least one processor; and
at least one memory connected to the at least one processor and storing instructions that, based on being executed by the at least one processor, cause the first device to perform operations comprising:
obtaining configuration information for dynamic channel access;
obtaining configuration information for semi-static channel access;
performing, based on information obtained by the first device, the dynamic channel access or the semi-static channel access;
transmitting, to a second device, through a physical sidelink control channel (PSCCH), first sidelink control information (SCI) for scheduling of a physical sidelink shared channel (PSSCH) and second SCI, based on success in the dynamic channel access or the semi-static channel access; and
transmitting, to the second device, through the PSSCH, the second SCI and data.

16-20. (canceled)

21. The first device of claim 14, wherein the information obtained by the first device is information related to a location of the first device.

22. The first device of claim 21, wherein, based on that the location of the first device is within an area configured for the first device, the semi-static channel access is performed by the first device.

23. The first device of claim 21, wherein, based on that the location of the first device is outside an area configured for the first device, the dynamic channel access is performed by the first device.

24. The first device of claim 21, wherein, based on that the information related to the location of the first device is unavailable, the dynamic channel access is performed by the first device.

25. The first device of claim 21, wherein, based on that reliability of the information related to the location of the first device is less than or equal to a threshold, the dynamic channel access is performed by the first device.
